(19) United States
(12) Patent Application Publication
(10) Pub. No.: US 2016/0173529 A1
(43) Pub. Date: Jun. 16, 2016

(54) CONTROLLED RESOURCE ACCESS TO MITIGATE ECONOMIC DENIAL OF SUSTAINABILITY ATTACKS AGAINST CLOUD INFRASTRUCTURES

(71) Applicant: KING FAHD UNIVERSITY OF PETROLEUM AND MINERALS, Dhahran (SA)

(72) Inventors: Zubair Ahmed BAIG, Perth (AU); Sadiq SAIT, Dhahran (SA); Farid Salem Binbeshr, Dhahran (SA)

(73) Assignee: KING FAHD UNIVERSITY OF PETROLEUM AND MINERALS, Dhahran (SA)

(21) Appl. No.: 14/970,152

(22) Filed: Dec. 15, 2015

Related U.S. Application Data
(60) Provisional application No. 62/092,085, filed on Dec. 15, 2014.

(51) Int. Cl. H04L 29/06; H04L 29/08

(52) U.S. Cl. CPC H04L 63/1458; H04L 67/10; H04L 63/0236; H04L 63/10

(57) ABSTRACT

Systems and methods include determining whether a CRPS value has been breached in a number of requests for access by an IP address, and dropping the requests for access when the CRPS value has been breached and a UTF value is below a minimum UTF value. The request number matching a RC value when the CRPS value has not been breached is determined. A Turing test is implemented when a) the request number matches the RC value, b) the request number does not match the RC value but the UTF value is below the minimum UTF value, or c) the CRPS value has been breached but the UTF value is not below the minimum UTF value. An investigator computing device implements a rate limit control to the cloud services based on the CRPS value, the RC value, and the UTF value.

### RELATED APPLICATION

This application claims priority to U.S. Provisional Application No. 62/092,085 filed Dec. 15, 2014, which is incorporated in its entirety by reference herein.

### BACKGROUND

Service providers have witnessed a rapidly growing demand to provide services to end-users in a timely manner. Certain users may disrupt routine cloud operations, resulting in a debilitating effect on the reputation of the service provider. One type of attack specifically affecting cloud services is the Economic Denial of Sustainability (EDoS) attack. Through such a malicious attack, the ability of the service provider to dynamically stretch and accommodate increasing numbers of requests from end-users is exploited, making it economically unviable for the service provider to sustain further demand for service from legitimate end-users.

Cloud computing has provided a novel paradigm to address the critical need for affordable and convenient resource availability to meet large-scale computing demands of contemporary applications. The cloud paradigm is based on the pay-per-use model, wherein vendors and service providers do not have to procure and maintain hardware and software resources to sustain their respective computing activity. Instead, most scalable services are purchased on a need basis.

Three different service models are defined for the cloud, including Infrastructure as a Service (IaaS), Platform as a Service (PaaS), and Software as a Service (SaaS). IaaS refers to providing storage and compute capabilities as services, usually through allocation of Virtual Machines (VMs) by the service provider. AmazonEC2 is an example suite that is built on the IaaS service model. “See Amazon Elastic Compute Cloud (Amazon EC2). Amazon elastic compute cloud (amazon ec2). http://aws.amazon.com/ec2/, Verified On: 9 Oct., 2013 (reference), incorporated herein by reference in its entirety.”

PaaS provides a layer of software (e.g., operating system) as a service for leasing out to the service providers to sustain design and deployment of application-layer services. Google App Engine is an example of a PaaS service model. “See Google App Engine. Google app engine. https://developers.google.com/appengine/, Verified On: 9 Oct., 2013 (reference), incorporated herein by reference in its entirety.”

Software as a Service (SaaS) refers to provisioning of software based on end-user demand as a service over the Internet. Salesforce.com is an example of a SaaS service model. “See Salesforce. Salesforce.com. http://www.salesforce.com/, Verified On: 9 Oct., 2013 (reference), incorporated herein by reference in its entirety.” All cloud services requested by an end user are managed by a service provider, which in turn sends forth these requests to the service provider, based on service level agreements.

According to a survey conducted by International Data Corporation (IDC), security ranked as the greatest challenge for cloud computing. “See International Data Corporation. New idc it cloud services survey: Top benefits and challenges. http://blogs.idc.com/ie/?p=730, 2009 (reference), incorporated herein by reference in its entirety.” Particular malicious attacks against the cloud, such as EDoS have remained largely unaddressed in the literature. The disruption of any service provisioned through the cloud can cause large scale damage to end-users, comprising both novice private end-user applications and sophisticated business applications wishing to harness the computing power of the cloud's elastic resource pool. Users of the cloud pay as they use, based on application needs. Elasticity of resource availability at the service provider is the key driving aspect for the growing popularity of the cloud paradigm. The ability of the service provider to differentiate between legitimate and malicious users/request types is critical for smooth and affordable resource usage at the service providers' end. However, a comprehensive mechanism for identifying routine cloud usage activity and distinguishing it from malicious activity is largely unaddressed in the literature.

Through an EDoS attack, the adversary class reserves a large pool of resources (within the service level agreement of the service provider) in order to make it financially unviable for the service provider to sustain further services for its users. The EDoS is defined as an attack that targets the service provider's economic resources by sending a huge number of requests that appear to be legitimate, exploiting the auto-scale feature of the cloud infrastructure, analogous to traditional DDoS attacks in [C. Hoff. Cloud computing security: From ddos (distributed denial of service) to edos (economic denial of sustainability). http://rationalsecurity.typepad.com/blog/2008/11/cloud-computing-security-from-ddos-distributed-denial-of-service-to-edos-economic-denial-of-sustaina.html, 2008 (reference)]. FIG. 1 illustrates an EDoS attack 100 in which the service provider's resources are expanded exponentially after an attack, causing an associated exponential increase in required economic resources of the service provider.

A summary of research work for addressing distributed malicious attacks against the cloud is given herein. An approach towards proving client commitment through solving crypto-puzzles is presented in [Soon Hin Khor and Aki Nakao. spow: On-demand cloud-based eddos mitigation mechanism. In In Proc. of the Fifth Workshop on Hot Topics in System Dependability, 2009 (reference)]. The purpose of the scheme is to thwart the effects of an EDoS attack, by granting access to only those clients willing to pay for service. Clients request for server access at the cloud provider's end by first defining the crypto-puzzle difficulty level, k and subsequently requesting for access. If an initial connection request is not successfully made during a given frame of time, the client may request for a more difficult puzzle to solve. Upon succeeding in solving a puzzle of a given complexity, the server establishes a secure communication channel for message exchange between the client and itself.

In [M. Naresh Kumar, P. Sujatha, V. Kalva, R. Nagori, A. K. Katukojwala, and M. Kumar. Mitigating economic denial of sustainability (edos) in cloud computing using in-cloud scrubber service. An EDoS mitigation technique for the cloud is proposed in In Proc. of the Fourth Intl' Conf. on Computational Intelligence and Communication Networks (CICN), 2012 (reference)]. The primary function of In-Cloud Scrubber Service is to generate a puzzle to check the legitimacy of the user for accessing the cloud service. The cloud service is switched between two modes: normal and suspected, based on the server and network bandwidth. In-Cloud Scrubber Service is used while the cloud service is operating in the suspected mode. The incoming requests during the normal mode will be immediately directed to the cloud service, whereas the incoming requests during the suspected mode will be directed to the In-Cloud Scrubber Service for verification purposes.

Client puzzles are known to provide weak access guarantees to end-users, as malicious users with high computational power may circumvent legitimate users from gaining access to cloud services. “See Virgil D. Gligor. Guaranteeing access in spite of service-flooding attacks. In In Proc. of Intl' Workshop on Security Protocols, pages 80-96, 2003 (reference), incorporated herein by reference in its entirety.” As a result, legitimate users may be facing a debilitating waiting time before they are actually guaranteed service.

Sqalli et al. proposed a mitigation technique called EDoS-Shield to protect the cloud against EDoS attacks. “See M. H. Sqalli, F. Al-Haidari, and K. Salah. Edos-shield—a two-steps mitigation technique against edos attacks in cloud computing. In Utility and Cloud Computing (UCC), 2011 Fourth IEEE International Conference on, pages 49-56, 2011 (reference), incorporated herein by reference in its entirety.” The key factor proposed for differentiating between legitimate and EDoS requests is through verification of human presence to control an end-user machine. A Virtual Firewall (VF) and a Verifier Node operate in tandem to perform the EDoS mitigation tasks. The firewall filters incoming requests based on a white list and a black list. The verifier node verifies the incoming requests using a Turing test, during first client access.

A Turing test is a test of a machine's ability to exhibit intelligent behavior equivalent to, or indistinguishable from, that of a human. Alan Turing proposed that a human evaluator would judge natural language conversations between a human and a machine that is designed to generate human-like responses. The evaluator would be aware that one of the two partners in conversation is a machine, in which all participants would be separated from one another. The conversation would be limited to a text-only channel, such as a computer keyboard and screen so that the result would not be dependent on the machine's ability to render words as speech. If the evaluator cannot reliably tell the machine from the human, the machine is said to have passed the test. The test does not check the ability to give correct answers to questions, but only on how close the answers resemble those a human would give.

If a user passes the Turing test, its IP address will be held in the white list and subsequent requests from the same address will be forwarded to the cloud scheduler for providing necessary services. In contrast, if a user fails the Turing test, its IP address will be held in the black list and subsequent requests from this address will be dropped by the firewall. However, the proposed approach has a few shortcomings. One of them is its vulnerability to IP spoofing. This problem might cause an EDoS attack if an attacker spoofs an IP address belonging to the white list of the verifier node.

In [Fahd Al-Haidari, Mohammed H Sqalli, and Khaled Salah. Enhanced edos-shield for mitigating edos attacks originating from spoofed ip addresses. In 11th IEEE International Conference on Trust, Security and Privacy in Computing and Communications (TrustCom), pages 1167-1174. IEEE, 2012 (reference)], an enhanced version of the scheme proposed in [M. H. Sqalli, F. Al-Haidari, and K. Salah. Edos-shield—a two-steps mitigation technique against edos attacks in cloud computing. In Utility and Cloud Computing (UCC), 2011 Fourth IEEE International Conference on, pages 49-56, 2011 (reference)] is presented, wherein, a Time To Live (TTL) field is appended alongside the IP address of cloud service requests. Through such an approach, the authors attempt to thwart the threat of spoofed IP addresses, as the distinctness in IP addresses when accompanied with a TTL field will help differentiate malicious spoofing clients from legitimate ones. Another scheme proposed to classify network traffic into anomalous based on mean absolute variance of TTL values is provided in [S. S. Chapade, K. U. Pandey, and D. S. Bhade. Securing cloud servers against flooding based ddos attacks. In Communication Systems and Network Technologies (CSNT), 2013 International Conference on, pages 524-528, 2013 (reference)].

Distributed Denial of Service (DDoS) attacks exploit the asymmetry between the network line rate and server processing rate to overwhelm server resources and circumvent legitimate clients from timely access to service. “See Z. A. Baig and K. Salah. Multiagent pattern recognition for detecting ddos attacks. IET Journal of Information Security, 4(4):333-343, 2010 (reference), incorporated herein by reference in its entirety.” In [P. Sujatha M. Kumar M. Kumar, R. Korra. Mitigation of economic distributed denial of sustainability (eddos) in cloud computing. In In Proc. of the Intl' Conf. on Advances in Engineering and Technology, 2011 (reference)], the authors have provided a contrast between traditional DDoS attacks and EDoS attacks. The distinguishing point between the two is stated as follows: while the former tends to deplete available resources to the end users, the latter attempts to inflate the bill of the service provider through exploiting the property of elasticity of cloud resources.

The authors in [S VivinSandar and Sudhir Shenai. Economic denial of sustainability (edos) in cloud services using http and xml based ddos attacks. International Journal of Computer Applications, 41(20):11-16, 2012 (reference)] propose an approach for ensuring that HTTP and XML based DDoS attacks do not trigger the auto-scaling feature of the cloud, thus ensuring that an EDoS does not transpire through such an attack. The contribution mainly focuses on studying the ability of a DDoS attack through protocol vulnerability exploitation, to cause an EDoS attack against the cloud.

In [Ruiping Lua and Kin Choong Yow. Mitigating ddos attacks with transparent and intelligent fast-flux swarm network. Network, IEEE, 25(4):28-33, 2011 (reference)], an adaptive swarm-based scheme is presented. Specific network routes are bound with specific client connections and dismantled once the cloud-based service is completely provided. Based on variations in the network terrain, the route selected for a given client is modified. Certain connections, such as SSL are not supported, due to the stateless nature of the scheme. In [Lanjuan Yang, Tao Zhang, Jinyu Song, JinShuang Wang, and Ping Chen. Defense of ddos attack for cloud computing. In Computer Science and Automation Engineering (CSAE), 2012 IEEE International Conference on, volume 2, pages 626-629, 2012 (reference)], a traceback mechanism is proposed for identifying perpetrators of DDoS attacks against the cloud. A filtering technique is implemented to ensure that only legitimate packets are seen through by the cloud virtual resources. It is also stated by the authors that when the server (or VM) capacity is not exceeded, even rogue packets are served by the proposed scheme.

In [A. Chonka and J. Abawajy. Detecting and mitigating hx-dos attacks against cloud web services. In In Proc. of the 15th International Conference on Network-Based Information Systems, 2012 (reference)], the authors proposed a mechanism to detect and mitigate the effects of an HX-DoS attack, defined as a combination of HTTP and XML messages, attempting to disrupt cloud activity. The proposed scheme, namely ENDER is comprised of two previously proposed schemes, CLASSIE, and Added Decision Making and Update (ADMU). “See Y. Xiang A. Chonka, W. Zhou and J. Singh. Detecting and tracing ddos attacks by intelligent decision prototype (idp). In In Proc. of the IEEE Workshop on Web and Pervasive Security, 2008 (reference); See C. Yu and H. Kai. Collaborative detection and filtering of shrew ddos attacks using spectral analysis. Journal of Parallel and Distributed Systems, 66(9):1137-1151, 2006 (reference); and See Y. Chen, Y. K. Kwok, and K. Hwang. Collaborative defense against periodic shrew ddos attacks in frequency domain. ACM Transactions on Information and System Security (TISSEC), 2005 (reference), each incorporated herein by reference in their entirety.” Messages arriving at the cloud provider's end are assessed by the CLASSIE analyzer, which is located one hop away from the router or host. The ADMU component of the proposed scheme makes a decision on whether to give access to a cloud resource by computing a likelihood of a message not previously classified, as constituting an attack.

In [Kirk Beaty, Ashish Kundu, Vijay Naik, and Arup Acharya. Network-level access control management for the cloud. In In Proc. of the IEEE International Conference on Cloud Engineering, 2013 (reference)], a network-level access control mechanism is proposed to prevent DoS attacks against cloud resources. A cloud access manager (CAM) operates within the proposed architecture. The CAM creates access zones. Zone 1 is implicit, implying that if one member of the zone has access to a certain cloud resource, others do as well. Moreover, cloud instances can be part of multiple zones simultaneously. Each zone has a certain set of privileges. In addition, policies can be added to the zones, for allowing further security controls.

In [“See Zhiyuan Tan., Aruna Jamdagni, Xiangjian He, Priyadarsi Nanda, and Ren Ping Liu. Triangle-area-based multivariate correlation analysis for effective denial-of-service attack detection. In In Proc. of the IEEE 11th International Conference on Trust, Security and Privacy in Computing and Communications, 2012 (reference); and “See Zhiyuan Tan., Aruna Jamdagni, Xiangjian He, Priyadarsi Nanda, and Ren Ping Liu. A system for denial-of-service attack detection based on multivariate correlation analysis. IEEE Transactions on Parallel and Distributed Systems, 2013 (reference), each incorporated herein by reference in their entirety], a traffic analysis-based approach for identifying DoS attacks is proposed. Statistical properties are extracted from network traffic based on multivariate correlation analysis. The scheme employs triangle areas to extract correlated feature information from network traffic. In order to accurately identify DoS traffic, a normal network traffic profile is defined through density estimations beforehand.

The “background” description provided herein is for the purpose of generally presenting the context of the disclosure. Work of the presently named inventors, to the extent it is described in this background section, as well as aspects of the description which may not otherwise qualify as prior art at the time of filing, are neither expressly nor impliedly admitted as prior art against the present invention.

### SUMMARY

Mechanisms are provided to identify suspicious service requests at the service provider's end and mitigate the effects of the EDoS attack through controlled resource usage. Systems and methods provide a regular assessment of incoming requests from end-users by comparing user activity (e.g., numbers and types of requests for cloud services) at the cloud provider and by controlling the rate at which a response to cloud service requests can be positively made. EDoS attack detection and mitigation systems and methods operate with low overhead and provide accurate classification of incoming requests into legitimate and malicious requests. Classification can be based on several criteria, including the trust factor assigned to an end-user, which can be varied based on the number of legitimate requests originating from the user. The proposed scheme is an in-cloud EDoS mitigation web service comprising three modules, namely packet filtering, proof-of-work technique, and egress filtering. Suspected clients of the cloud services must prove their commitment for gaining service access by solving crypto-puzzles. Only clients succeeding in solving the crypto-puzzles are granted access to the cloud services.

An embodiment includes an EDoS mitigation system, including a firewall configured with circuitry to filter incoming traffic from one or more users and to maintain a table of IP addresses of suspected users. The EDoS mitigation system also includes an investigator computing device configured with circuitry to monitor legitimacy of the one or more users forwarded from the firewall when an incoming IP address matches a listed IP address within the table of IP addresses. The investigator computing device implements a rate limit control at which a given user can request access to the cloud services based on concurrent requests per second (CRPS), a random check (RC), and a user trust factor (UTF). The EDoS mitigation system also includes a load balancer computing device configured with circuitry to schedule jobs received from the firewall or the investigator computing device and to automatically scale incoming requests for access to the cloud services when the threshold is exceeded. The EDoS mitigation system also includes a database having a rate limit table for tracking past behavior of the one or more users and a copy of the table of IP addresses of suspected users. The EDoS mitigation system also includes one or more observer node devices, each configured to probe local resource usage of one or more associated computing devices and to instruct the firewall to redirect subsequent requests for access to the cloud services to the investigator computing device when network link utilization, CPU utilization, or memory allocation usage has been exceeded.

Another embodiment includes a method of mitigating an EDoS, including determining whether a CRPS value has been breached in a number of requests for access to cloud services by an IP address, and dropping the requests for access when the CRPS value has been breached and a UTF value is below a minimum UTF value. The method also includes determining whether the request number matches a RC value when the CRPS value has not been breached. The method also includes implementing a Turing test when any of the following events occur: a) the request number matches the RC value, b) the requests number does not match the RC value but the UTF value is below the minimum UTF value, or c) the CRPS value has been breached but the UTF value is not below the minimum UTF value. Steps of the method are implemented via an investigator computing device configured by circuitry to monitor legitimacy of IP addresses forwarded from a firewall node and to implement a rate limit control at which a given user can request access to the cloud services based on the CRPS value, the RC value, and the UTF value.

Another embodiment includes a method of mitigating an EDoS, including receiving via a firewall computing device requests for access to cloud services from a plurality of users at one or more IP addresses, and investigating via an investigator computing device one or more of the received requests forwarded from the firewall when network link utilization, CPU utilization, or memory allocation usage has been exceeded. The method also includes implementing via the investigator computing device a Turing test with one of the plurality of users associated with an IP address having an exceeded threshold rate, and verifying via the investigator computing device a request rate, updating a UTF, and granting access when the one user passes the Turing test. The method also includes delaying via the investigator computing device access for a non-verified request rate, updating the UTF, and updating a table of IP addresses of suspected users when the one user does not pass the Turing test.

The foregoing paragraphs have been provided by way of general introduction, and are not intended to limit the scope of the following claims. The described embodiments will be best understood by reference to the following detailed description taken in conjunction with the accompanying drawings.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings, wherein:

FIG. 1 illustrates an EDoS attack;

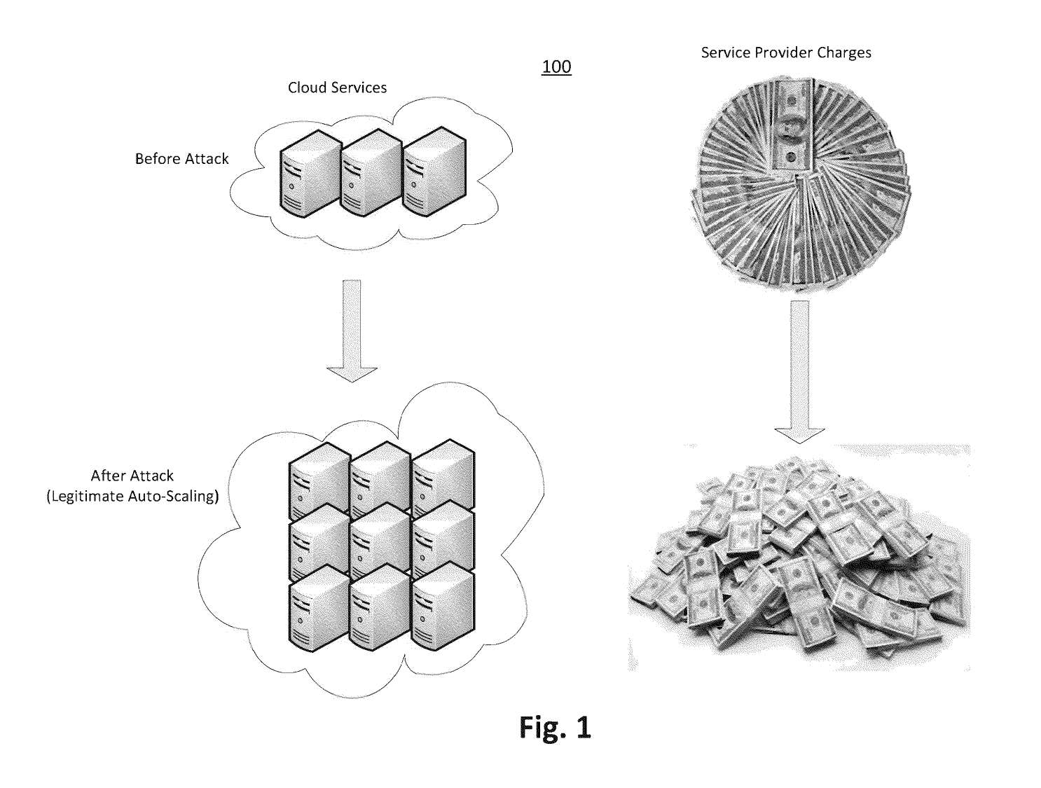

FIG. 2 illustrates an exemplary architecture of an EDoS mitigation system according to an embodiment;

FIG. 3 illustrates an exemplary EDoS mitigation system and method according to an embodiment;

FIG. 4 illustrates an exemplary process of incorporating a load balancer node according to an embodiment;

FIG. 5 is an exemplary algorithm for executing an EDoS detection and mitigation process according to an embodiment;

FIG. 6 is a graph of a malicious user ratio with respect to the EDoS attack resilience according to an embodiment;

FIG. 7 is a graph of the number of optimal accesses granted, wₒₚₜ to individual users of the cloud for varying numbers of malicious users, r according to an embodiment;

FIG. 8 is a graph of increasing a user base of the cloud (inclusive of both legitimate and malicious) on the numbers of accesses granted according to an embodiment;

FIG. 9 is a graph of increasing a user base of the cloud (inclusive of both legitimate and malicious) on the numbers of accesses granted for a fixed r=50% according to an embodiment;

FIG. 10 is a graph illustrating the effect of increasing numbers of cloud users on the end-user perceived delay for varying r according to an embodiment;

FIG. 11 is a graph illustrating the effect of increasing numbers of cloud users on the end-user perceived delay for the value of r fixed at 50% according to an embodiment;

FIG. 12 is a graph illustrating the EDoS attack rate against computer processing unit (CPU) usage of cloud services according to an embodiment;

FIG. 13 is a graph illustrating the EDoS attack rate against CPU usage of cloud services with auto-scaling, but without mitigation technique according to an embodiment;

FIG. 14 is a graph illustrating the EDoS attack rate against CPU usage of cloud services with both auto-scaling and mitigation technique according to an embodiment;

FIG. 15 is a graph illustrating experimental results of the cost of malicious attackers on cloud services according to an embodiment;

FIG. 16 is a graph illustrating experimental results which affect the response time according to an embodiment;

FIG. 17 is a graph illustrating experimental results of false negatives for one user at CRPS=1 according to an embodiment;

FIG. 18 is a graph illustrating experimental results for a constant UTF value and CRPS=1 for varied values of UTF decrement according to an embodiment;

FIG. 19 is a graph illustrating experimental results for false negatives at CRPS=5 for varied values of UTF decrement according to an embodiment;

FIG. 20 is a graph illustrating experimental results for a constant UTF value and CRPS=5 for varied UTF decrements according to an embodiment;

FIG. 21 is a graph illustrating experimental results of false negatives when an attacker sends fewer requests than allowed by the system at CRPS=5 for varied UTF decrement values according to an embodiment;

FIG. 22 is a graph illustrating experimental results of the UTF value when an attacker sends fewer requests than allowed by the system at CRPS=5 for varied UTF decrement values according to an embodiment;

FIG. 23 is a graph illustrating experimental results of false negatives when an attacker sends more requests than allowed by the system at CRPS=5 for varied UTF decrement values according to an embodiment;

FIG. 24 is a graph illustrating experimental results of the UTF value when an attacker sends fewer requests than allowed by the system for CRPS=5 with varied UTF decrement values according to an embodiment;

FIG. 25 is a graph illustrating experimental results of false negatives for CRPS=10 with varied UTF decrement values according to an embodiment;

FIG. 26 is a graph illustrating experimental results of the UTF value with CRPS=10 for varied UTF decrement values according to an embodiment;

FIG. 27 is a graph illustrating experimental results of false negative results of multiple numbers of malicious users for groups of one, ten, fifty, and one hundred malicious users according to an embodiment;

FIG. 28 is a graph illustrating the effect of false negatives from multiple users on CPU usage for groups of one, ten, fifty, and one hundred malicious users according to an embodiment;

FIG. 29 is a block diagram illustrating an exemplary electronic device according to an embodiment;

FIG. 30 is a block diagram of an exemplary computing device according to an embodiment;

FIG. 31 is a block diagram of an exemplary data processing system according to an embodiment;

FIG. 32 is a block diagram of an exemplary CPU according to an embodiment;

FIG. 33 illustrates an exemplary cloud computing system according to an embodiment; and

FIG. 34 illustrates an exemplary algorithmic flowchart for performing a method of mitigating an EDoS according to an embodiment.

### DETAILED DESCRIPTION

EDoS attack detection and mitigation systems and methods for cloud infrastructure are given herein. The systems and methods detect and mitigate the effects of an EDoS attack against the auto-scaling feature of the cloud, where auto-scaling is defined as the characteristic of the cloud that allows the service provider to request scaling up or down of cloud resources automatically to accommodate variable user demands. Two parameters, namely threshold and duration are considered while classifying incoming requests as normal or anomalous. Threshold is the maximum number of requests beyond which the auto-scaling feature is activated, whereas duration is the length of time for which the auto-scaling remains active.

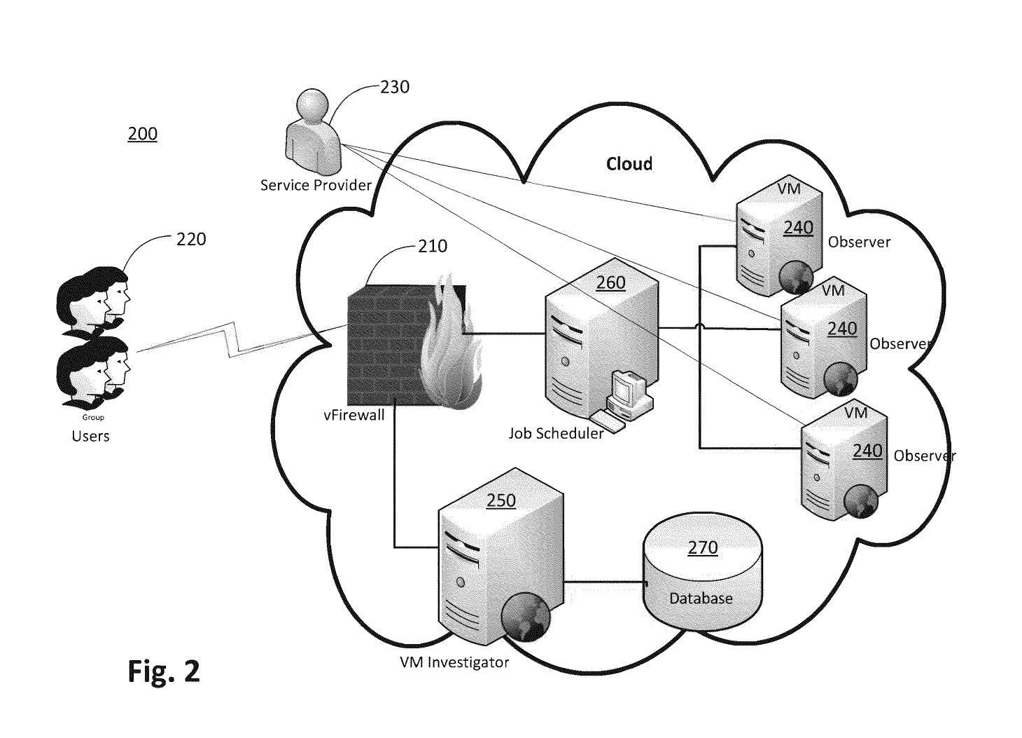

In FIG. 2, components of the EDoS attack detection and mitigation system architecture 200 (with the VM Investigator Access Computation considered as a sub-component) are given. A vFirewall node 210 is a front-end filtering device responsible for analyzing incoming requests from users 220 to a service provider 230. White list user requests, which will be described in more detail herein, are directed to one or more VM Observer nodes 240. Requests found to be originating from black-listed users are directly sent forth to a VM Investigator node 250. The vFirewall node 210 therefore does not drop any requests from IP addresses found in the black list. The VM Investigator node 250 follows the same procedure for both cases, in which black-listed requests are directly received and when the VM Observer node 240 does its probing on inter-VM traffic and forwards the requests to the VM Investigator node 250.

A VM job scheduler node 260 provides an even distribution of jobs to individual VMs. These jobs are distributed based on several techniques for job scheduling proposed in the literature, such as those found in [“See K. Dutta, R. B. Guin, S. Chakrabarti, S. Banerjee, and U. Biswas. A smart job scheduling system for cloud computing service providers and users: Modeling and simulation. In In Proc. of the 1st Intl' Conf. on Recent Advances in Information Technology (RAIT), pages 346-351, 2012 (reference), incorporated herein by reference in its entirety.” “See M. D. Assuncao, M. A. S. Netto, F. Koch, and S. Bianchi. Context-aware job scheduling for cloud computing environments. In Utility and Cloud Computing (UCC), 2012 IEEE Fifth International Conference on, pages 255-262, 2012 (reference), incorporated herein by reference in its entirety.” “See Shiyao Chen, Ting He, H. Y. S. Wong, Kang-Won Lee, and Lang Tong. Secondary job scheduling in the cloud with deadlines. In Parallel and Distributed Processing Workshops and Phd Forum (IPDPSW), 2011 IEEE International Symposium on, pages 1009-1016, 2011 (reference), incorporated herein by reference in its entirety.” “See Jing Liu, Xing-Guo Luo, Xing-Ming Zhang, Fan Zhang, and Bai-Nan Li. Job scheduling model for cloud computing based on multi-objective genetic algorithm. International Journal of Computer Science, 10(1):134-139, 2013 (reference), incorporated herein by reference in its entirety.”]

A database 270 of the EDoS system architecture 200 is mainly used by the rate limit technique adopted by the VM Investigator node 250 for further analysis of black-listed end-user requests. It has two tables, namely Ratelimit and Blacklist. The Ratelimit table helps keep track of the past behaviour of end-users. This table includes five fields, namely IP address, LastActivity Time Stamp, RequestsCount, User Trust Factor (UTF), and the Count. The IP address represents the user's source IP address for identification. The LastActivity parameter stores the last seen activity for a given user. RequestsCount keeps track of the number of requests made by a user in a single minute. The UTF maintains a value based on the success or failure of an end-user in responding to a posed Turing test, and the Count is used to store the number of requests made by an end-user during a single second.

The Blacklist table stores the IP addresses of suspected users. These IP addresses are a copy of those held in the black list of the vFirewall node 210. The purpose of this replication is to provide rapid access to these IP addresses for further analysis and/or dropping of requests by the VM Investigator node 250. The database 270 can be located alongside the VM Investigator node 250.

The job distribution may still lead to overwhelming of resources at a VM Observer node 240. Therefore, a VM Observer process is operational within each VM Observer node 240 for probing local resource usage. It is responsible for probing of resource usage within the VM node. During any frame of time, the thresholds of CPU, memory, or network usage (through inter-VM communication), as stipulated at initialization time, must not be surpassed. The VM usage metrics observed by the VM Observer node 240 process includes a) network link utilization, b) CPU utilization, and c) virtual memory allocation. Upon observing exceeding resource usage at a VM node, the VM Observer node 240 redirects subsequent requests to the VM Investigator node 250 for further analysis.

The VM Investigator node 250 is triggered either by the vFirewall node 210 (for black-listed request origins) or by the VM Observer node 240 if the VM node resource usage crosses pre-defined thresholds. It executes a series of steps to provide selective access to subsequent service requests from suspicious users. Through this procedure, a limited access permission and priority for cloud resource access is granted, based on specified criteria to prevent indiscriminate resource allocation to malicious users that are perpetrating an EDoS attack. Only legitimate users (not marked as black listers) will continue with their cloud resource access, uninterrupted. Through deployment of the VM Investigator node 250, auto-scaling will not incur undue losses because of an EDoS attack against the service provider 230, due to the presence of malicious users in the network.

A rate limit technique is used to control the rate at which any given end-user may request access to cloud services. Through this technique, a limited access permission for cloud services is granted to each user, based on factors, including Concurrent Requests Per Second (CRPS), Random Check (RC), and User Trust Factor (UTF).

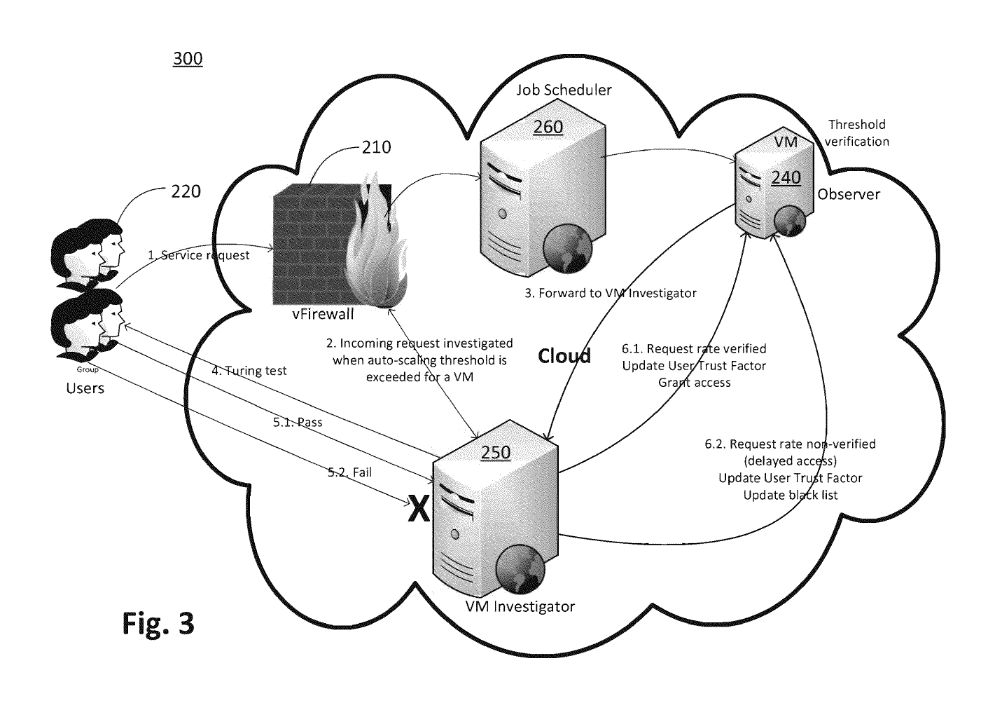

FIG. 3 illustrates an exemplary process 300 of detecting and mitigating an EDoS attack. A service request is made from a user 220, which is filtered at vFirewall node 210. The incoming request is investigated by VM Investigator node 250 when the auto-scaling threshold is exceeded for a VM node. The request is forwarded to job scheduler node 260 and on to VM Observer node 240 where the threshold is verified. The request is forwarded to VM Investigator node 250 and a Turing test is conducted with user 220. If the user 220 passes the Turing test, the request rate is verified, the UTF is updated, and access is granted. If the user 220 fails the Turing test, the request rate is non-verified, the UTF is updated, the black list is updated, and access is delayed or denied.

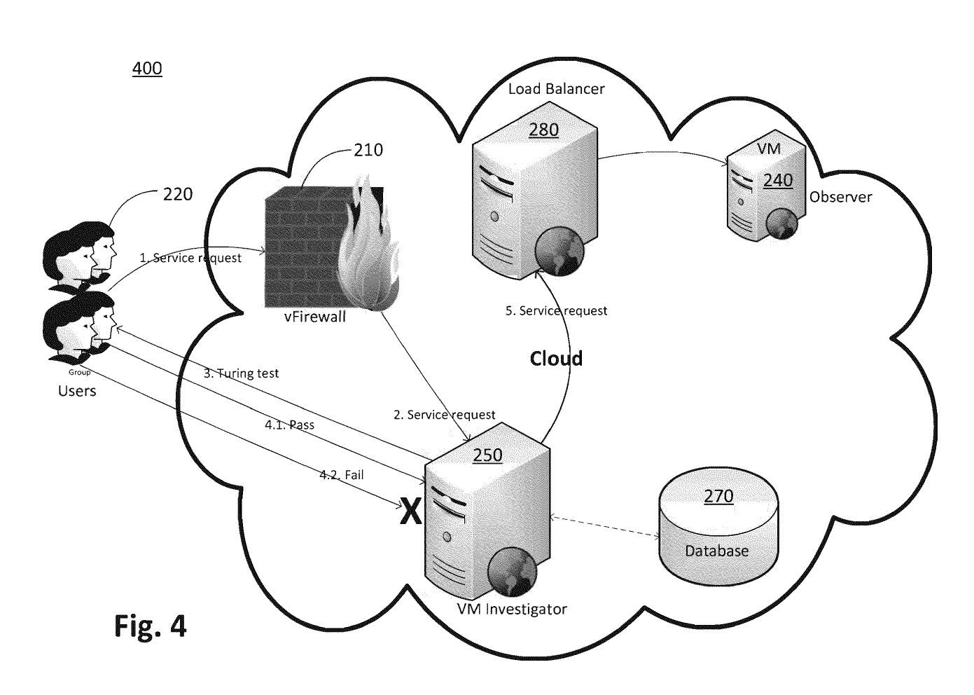

FIG. 4 illustrates an exemplary process 400 of incorporating a load balancer node 280 into process 400. A load balancer node provides scheduling of jobs that arrive from the vFirewall node or from the VM Investigator node. In addition, the load balancer node (e.g., Citrix NetScaler) is responsible for auto-scaling and monitoring its parameters in conjunction with the cloud platform software (e.g., Citrix CloudPlatform). Moreover, it adds a rule to the vFirewall node that directs all incoming requests to the VM Investigator node, when the threshold parameter is exceeded.

A service request is made from a user 220, which is filtererd at vFirewall node 210. The service request is forwarded to VM investigator node 250, which conducts a Turing test with the user 220. If the user 220 passes the Turing test, the service request is forwarded to load balancer node 280 and on to VM Observer node 240. If the user 220 fails the Turing test, access is denied and the service request is not forwarded for processing.

The CRPS is a variable that maintains a value to define the upper bound on the number of requests permitted from a single IP address to arrive during a single second. Breaching the CRPS is determined by checking the values of Count and LastActivity fields of a given user, obtained from the vFirewall node. For instance, if it is assumed the CRPS value is 5, this implies the system allows five requests to arrive from a single user during any second of the system clock. The system will check the Count field for a given user to confirm the number of access requests arriving from a single user during one second of activity. If a sixth request (>5) for the same IP address arrives during the same period of time, the time difference between the current system time and the LastActivity parameter of the same IP address is checked. The user breaches the CRPS if the time difference is less than one second. If the time difference is more than one second, the Count parameter for the IP address is reset to 1, indicating a legitimate request for cloud service access.

The RC parameter helps identify intelligent attackers who can subvert the system by sending requests to bypass the capability of the CRPS parameter in identifying such attacks, assuming the attacker can accurately guess the CRPS value. RC values are random numbers picked from the interval [1,TRPM], where TRPM stands for Total Requests Per Minute and its value equals CRPS*60, and its count (RC values count) is equivalent to the CRPS value.

Intelligent attackers can subvert the system by sending requests acceptable by the system when compared against the defined parameters. VM Investigator node selects the RC values randomly. In case the attacker sends fewer requests than the predefined CRPS value, it is expected that the random check may not take place while the RC value(s) are selected from the end of the interval (i.e, [1,TRPM]). To avoid such a situation, the interval [1,TRPM] is divided equally into sub-intervals (if CRPS>1), based on the RC values count. VM Investigator node picks an RC value from each interval. For instance, if CRPS is set to 3, RC values count will also be equal to 3, TRPM will be 180, and the RC values will be picked from the interval [1,180]. Since RC values count is 3, the interval [1,180] will be divided into 3 sub-intervals, [1,60], [61,120], and [121,180]. VM Investigator node will subsequently pick an RC value (three RC values in this case), from each interval randomly. RC values count and TRPM are directly proportional to the CRPS value. For example, if CRPS is set to 1, RC will be 1, and TRPM will be 60. VM Investigator node counts the user's requests per minute. When the end-user request number matches the selected RC value(s) requests for cloud service access through the VM Investigator node, this check takes place. VM Investigator node resets the end-user's request count (identified by the RequestsCount field) to zero each minute.

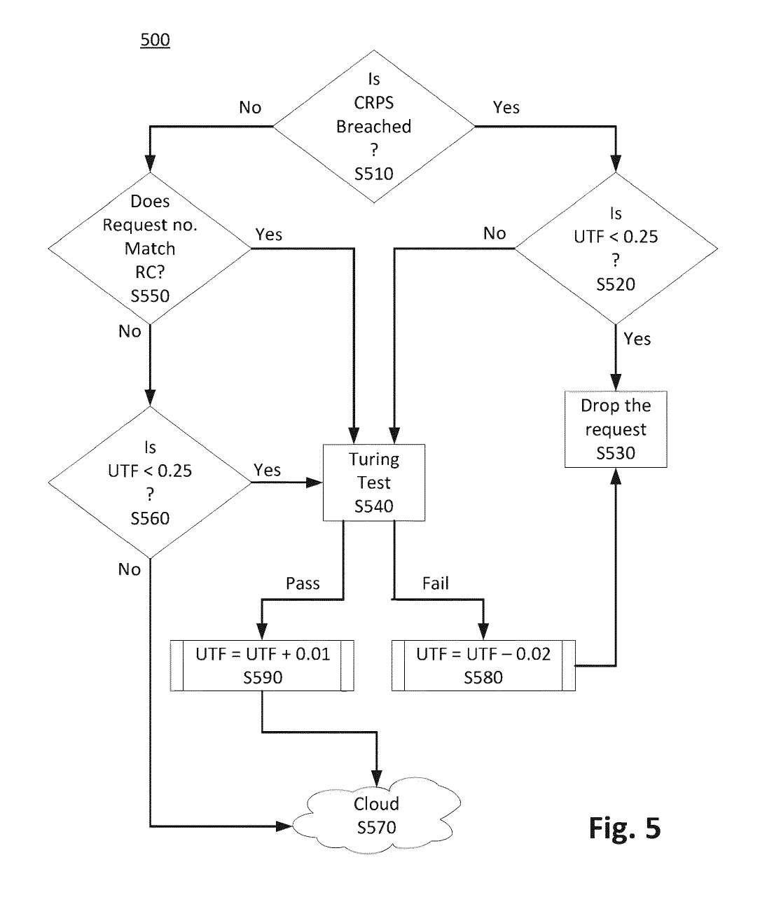

FIG. 5 is an exemplary algorithm 500 for executing an EDoS detection and mitigation process, such as process 300 and 400 described herein. It can be observed from FIG. 5 that the VM Investigator node first determines whether a user exceeds the CRPS value in step S510. If the CRPS value is exceeded (a “yes” decision in step S510), the UTF value is determined in step S520. The purpose of this step is to reduce false positives with a reasonable degree of accuracy (e.g., legitimate requests from different users with shared IP addresses arriving at the same time). If the UTF value is found to be less than 0.25 (i.e., a bad UTF), the VM Investigator node drops the request in step S530. If the UTF value is found to be more than 0.25 (a “no” decision in step S520), a second chance is granted to the user to successfully gain cloud service access upon passing the Turing test in step S540.

If the user does not exceed the CRPS (a “no” decision in step S510), the VM Investigator node determines whether the corresponding request number matches the RC value(s) generated by the random number generator in step S550. The purpose of this step is to detect smart attackers with a reasonable degree of accuracy. If the user is new to the system, its information is stored in the RateLimit table of the database and its request is directly forwarded to the load balancer node. If the request number matches the RC (a “yes” decision in step S550), a Turing test is conducted with the user in step S540. If the request number does not match the RC (a “no” decision in step S550), a determination is made whether the UTF is less than 0.25 in step S560. If the UTF is less than 0.25 (a “yes” decision in step S560), a Turing test is conducted with the user in step S540. If the UTF is not less than 0.25 (a “no” decision in step S560), access to cloud services is granted in step S570.

The UTF variable provides a crude (1st level) classification of cloud service requests originating from end-users. The value of UTF is calculated at the VM Investigator node when a request from a new user with a certain IP address arrives at the VM Investigator node.

The default value of UTF can be 0.5. For a trust framework, UTF can be classified into three levels, including good, average, and bad. Intervals were selected for the UTF of a good UTF (0.75-1], an average UTF [0.25-0.75], and a bad UTF [0-0.25). However, other intervals can be used with embodiments described herein, and the values used herein are given for illustrative purposes only.

The UTF value varies based on the outcome of the Turing test in step S540. If a user fails (e.g., responds with a wrong answer or if a request times out), the UTF value is decremented by 0.02 in step S580. The request is subsequently dropped in step S530. If the user passes the test, the UTF value is incremented by 0.01 in step S590. Access to cloud services is subsequently granted in step S570.

To penalize failured users, the UTF increments change less rapidly than UTF decrements. The VM Investigator node checks the UTF value of all users periodically. Users with a bad UTF value are marked as malicious and as a consequence, their IP addresses are held in the black list of the vFirewall node. Users with good UTF values are removed from the black list (if they are found in the black list).

The resource usage thresholds defined and utilized by the VM Observer node provide bounds on CPU, memory, and network usage to help identify suspicious users of the service provider, thereby redirecting them to the VM Investigator node for initiating the selective access process. A UTF parameter is initialized at the VM Investigator node to help calculate the number of accesses the VM Investigator node can provide to a given user in a given frame of time. If the UTF value for a given user reaches the maximum (i.e. one), then the user is removed from the black list and this information is conveyed to the vFirewall node. On the contrary, when the UTF value reaches zero, all subsequent requests from this IP address are dropped and the system administrator is informed accordingly.

A second algorithm executed at the VM Investigator node is given herein, wherein the VM investigator node determines a number of accesses (wₒₚₜ) to give. The wₒₚₜ value is calculated at the VM Investigator node for providing an upper bound on the number of service requests a given end-user may gain with an expiration time. The purpose of this rate limit is to avoid overwhelming of VM Investigator node resources by the end-users (either through EDoS attacks or through flash crowding). It is assumed that the aggregate rate of arrival of requests from the clients is less than or equal to the application processing rate Lᵢ/T at the VM Investigator node, where Lᵢ is the length of the buffer to hold cloud resource access requests from an end user i, and T is the worst case time window length to handle all requests within the server's buffer (collective resource availability of all operational VMs).
Input: Input Request from the VM Observer node, with user ID i.
Output: Response to VM Observer node.
1. Accept Incoming Request from VM Observer node.
2. Send Turing Test to i
3. If (Response Received Delay (i)<Acceptable bound (UTFᵢ))

Forward Request to VM Observer node(i) Confirming a Pass (Client legitimacy)

Update UTFᵢ
else

Execute Equation 2 (defined hereunder) and Compute number of accesses (wₒₚₜ) to grant to user i.
Update UTFᵢ
Update Black List
4. Update wₒₚₜ of user i.

The algorithm steps of execution at the VM Investigator node when user requests are directed by the vFirewall node to the VM nodes is given herein.

The modified client request forwarded to the VM Investigator node by the Virtual Machines is given by:

Client Request={Source IP address, Time Request Received tₛ, Overall Usage ObserverNode }.

Based on the UTFᵢ value, the end-user is requested to respond to the Turing test. The VM Investigator node generates an estimate on the number of accesses to grant to the user i during a given frame of time. The state information of an end-user i stored within the VM Investigator node is:

state information={start time tᵢ, end time tᵢ₊₁, Max Access Counter wₒₚₜ, Source IP Address, Time Request Received tₛ}

where,

$$1 \leq {w}_{opt} \leq \frac{L \cdot v}{n} ,$$

for n end-users attempting to access VM resources in parallel (assumption: based on the service level agreement, the maximum amount paid by the service provider should not be exceeded). v is the number of operational VMs at the service provider.
tᵢ=t_{w}+Δ, where Δ is the network delay between the VM Observer node and VM Investigator node.

tᵢ₊₁=tᵢ+wₒₚₜ·(τ+2.Δ+δᵢ).

δᵢ is an estimate on the minimum interarrival delay estimate between two consecutive requests from the same end-user i.

Upon successfully passing the Turing test, the VM Investigator node generates two values, namely, tᵢ and tᵢ₊₁, which are the beginning and end of the time frame for access control. These two values are computed based on the availability of VM resources as well as on the number of end-users attempting to access the VM services in a given frame of time. A minimum delay of Δ for network communication between the user and the service provider is incorporated to ensure that unfair denial of access does not occur for end-users due to communication factors. The end time tᵢ₊₁ is derived based on the number of accesses granted to a user, wₒₚₜ. For larger numbers of accesses granted, the time frame is longer and vice versa. The length of time window wₒₚₜ is optimized and computed based on Equation 2 (defined hereunder).

A worst case scenario is when the waiting time for a legitimate client to gain access to a cloud-based service is higher than expected. The delay incurred will not be unbounded because the number of accesses granted to each end-user is pre-computed based on the optimal window length, wₒₚₜ. Eventual access implies that if a large set of requests are anticipated from a given user, service providers should accordingly request that number of accesses from the service provider ahead of time to prevent a denial-of-service situation for legitimate users subscribed to the service provider. The access count, wₒₚₜ, to be given to a user by the VM Investigator node directly affects the end-user quality of experience. An exceedingly high number of accesses given to a single user would preempt service access by other legitimate users, and very few accesses will invariably overwhelm the VM Investigator node with frequent requests for service access by the users. The overhead for the former case is felt by other legitimate users of the cloud, with the imminent possibility of malicious users gaining server resource time, subsequently refraining from actual service usage, and causing an EDoS. On the other hand, with very few accesses granted, frequent users of the cloud services, as well as malicious nodes with the intention of gaining server access, will overwhelm the VM Investigator node, thereby causing service disruptions through a DoS against the VM Investigator node.

Optimizing the number of accesses that must be given to the end-user is based on the following a third algorithm.

Let c₁ be the unit cost of communication between a cloud end-user and the VM Investigator node, assuming the VM Investigator node is present behind a vFirewall node. Let c₂ be the cost of resource under-utilization at the service providers' end due to non-utilization of allocated time by malicious users. If A is the estimate access counter for a given cloud service Cₛ, and i is the percentage of legitimate clients of the system, where 0<i<1, then the total cost incurred by the system when the selective access scheme is operational is given by:
Input: Input Request from the vFirewall node, with user ID i.
Output: Response to VM, Response to vFirewall node.
1. Accept Incoming Request from vFirewall node.
2. Send Turing Test to i
3. If (Correct Response Received Delay (i)<Constant Tolerance Value)

Forward Request to VM (i) through vFirewall node
Confirming a Pass (Client legitimacy))

Update UTFᵢ
else

Execute Equation 2 (defined hereunder) and Compute number of accesses (wₒₚₜ)to grant to user i.

Update UTFᵢ

Update Black List
4. Update wₒₚₜ of user i.

The algorithm steps of execution at the VM Investigator node when the vFirewall node deals with black listed users for a given service provider is given by:

$${C}_{total} = \frac{{c}_{1} \cdot A}{{w}_{opt}} + {C}_{2} \cdot ( 1 - i ) \cdot {w}_{opt} \qquad ( 1 )$$

Minimizing the total cost of the scheme given above provides an estimate on the optimal number of accesses to be given to a client, wₒₚₜ, for a given cloud service, as follows:

$${w}_{opt} = \sqrt{\frac{{c}_{1} \cdot A}{{c}_{2} \cdot ( 1 - i )}} \qquad ( 2 )$$

Based on the formulation provided in Equation 2, the start and end times, ti, and tᵢ₊₁, can be computed.

Simulation of results is given herein to illustrate how system and method embodiments described herein mitigate an EDoS attack against the VM resources of the cloud. In addition, the access count granted to individual users of the cloud based on varying system-level parameters was analyzed, as previously specified. The simulation results portraying the average delay perceived by an end-user when the scheme is operating were studied. The average buffer length for an end-user (i) at the VM Investigator node is taken to be 100, the average inter-arrival time between two consecutive requests from the same user δi is taken as 10 ms, and the estimated access count A was taken as 100. In addition, the costs imposed by the mitigation scheme c1 and through an EDoS attack, c2, were evenly taken as 0.5 each.

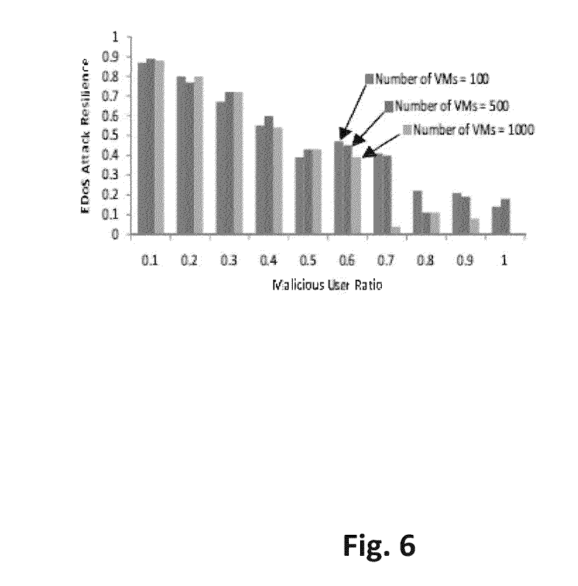

FIG. 6 is a graph of a malicious user ratio with respect to the EDoS attack resilience. Tests were made for 100, 500, and 1000 VMs. FIG. 6 illustrates the ability of the system and method to reduce the effects of the EDoS attack on the service provider's resources, as well as on the economic damage incurred through the attack on the service provider. An EDoS attack is an attempt by the adversary to reserve virtual machines at the service provider, so as to incur unwanted and wasteful costs on the service provider, thus affecting its ability to afford provisioning of services to its legitimate client base. The resilience to the attack is measured as the ratio of wasteful time slots assigned to malicious users, against those slots assigned to legitimate users of the cloud.

With an increasing number of malicious users, r, the overall capability of the detection scheme diminishes, as is evident from FIG. 6. Nearly 90% resilience is attained with r=10%, whereas only a 12% resilience is attained with 90% of the user base being malicious. An increasing number of operational VMs in the cloud will improve the performance of the attack mitigation scheme. However, this improvement is offset with increasing numbers of malicious users. Therefore, increasing VMs does not significantly affect the ability of the scheme to mitigate EDoS attack effects. Apart from the case where r=70% where a larger number of VMs led to degradation in performance, other values of r yielded comparable performances for all three numbers of VMs tested, i.e., v=100, 500, and 1000.

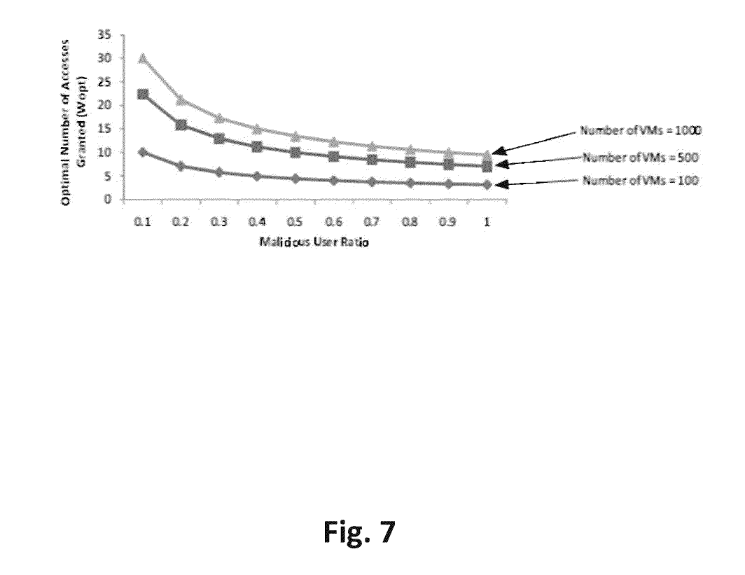

FIG. 7 is a graph of the number of optimal accesses granted, wₒₚₜ to individual users of the cloud for varying numbers of malicious users, r. The value of r selected for deriving wₒₚₜ was assumed based on empirical service provider behavior and can be selected by the system administrator at network initialization time. The number of VMs, v has a direct effect on the number of accesses granted. Fewer VMs would demand fewer numbers of incoming requests to the service provider during any given frame of time. On the contrary, with increasing numbers of operational VMs, the service provider has more room to accommodate additional numbers of requests from end-users. If higher numbers of malicious users, r are expected, these access counts can be reduced accordingly.

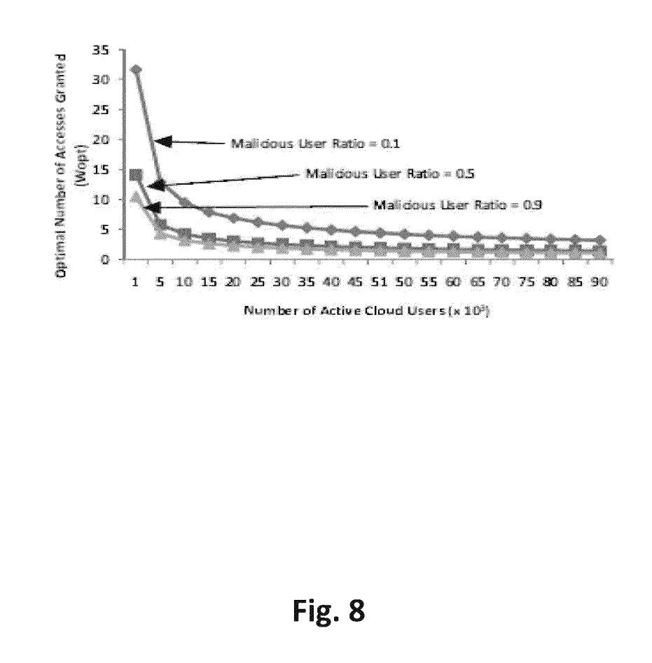

Further simulations were conducted to test the effect of increasing user base of the cloud (inclusive of both legitimate as well as malicious) on the numbers of accesses granted, as illustrated by the graph of FIG. 8. With r=10% and number of VMs=1000, nearly 33 accesses are granted to each user during a given frame of time when only 2000 users are availing cloud services. Increasing the user base reduces the number of accesses granted. Therefore, with N=100K and r=10%, only 4 accesses are granted per-user. Increasing the anticipated number of malicious users leads to fewer accesses granted. For N=50K, 6 accesses are granted for r=10% and only 1 access is granted for r=90%, thus showing the adaptability of the scheme to various attack scenarios.

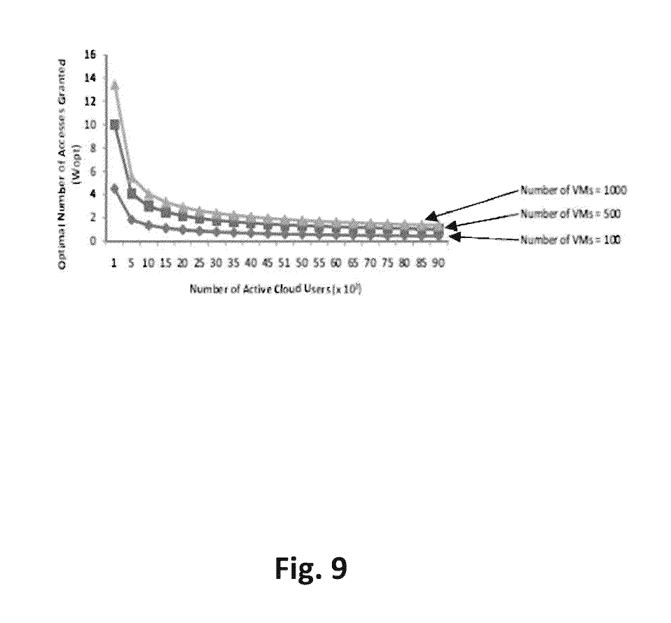

In the graph of FIG. 9, a similar trend to that shown in FIG. 8 is illustrated for a fixed r=50% and different values of v. A large number of VMs operating at the service provider's end allowed the system to provide more numbers of accesses to the end-users and vice versa. For v=1000, roughly 2 accesses were granted for N=100K, whereas for v=100, only 1 access per user was granted. Smaller values of N allowed more numbers of accesses to be granted to each end-user, with nearly 14 accesses granted for v=1000 and N=1000, and only 5 accesses granted for v=100 and N=1000.

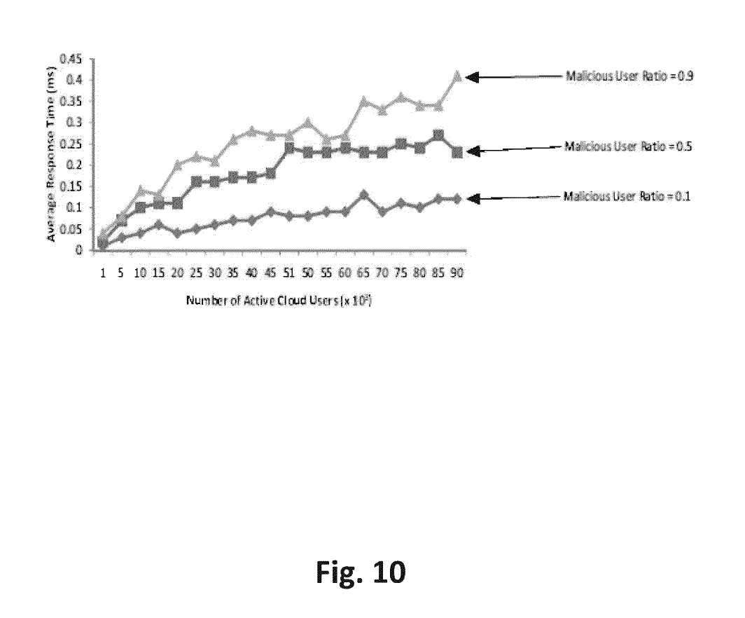

The end-user perceived delay is a very important measure of the performance and usability of the system and method. The delay incurred by the EDoS mitigation scheme was tested in the presence of variable numbers of cloud malicious users, as well as a variable number of VM nodes. FIG. 10 is a graph illustrating the effect of increasing numbers of cloud users on the end-user perceived delay for varying r and fixed v=1000. The overall delay appertaining to the operations of the scheme were derived based on factors, including a) computational delay associated with the calculation of the optimal number of accesses (wₒₚₜ) to be given, and b) queueing delay in the service provider's storage buffer. The delay associated with (b) is common to all service providers, whereas the delay incurred by the scheme is reflected only through (a) above. For larger values of r, the delay incurred is higher and for smaller r, the delay is less. This behavior is attributed to fewer numbers of accesses granted for larger r and vice versa. A delay of nearly 0.4 ms is observed with 100K active users and r=90%, whereas only 0.1 ms is observed for the same number of users with r=10%.

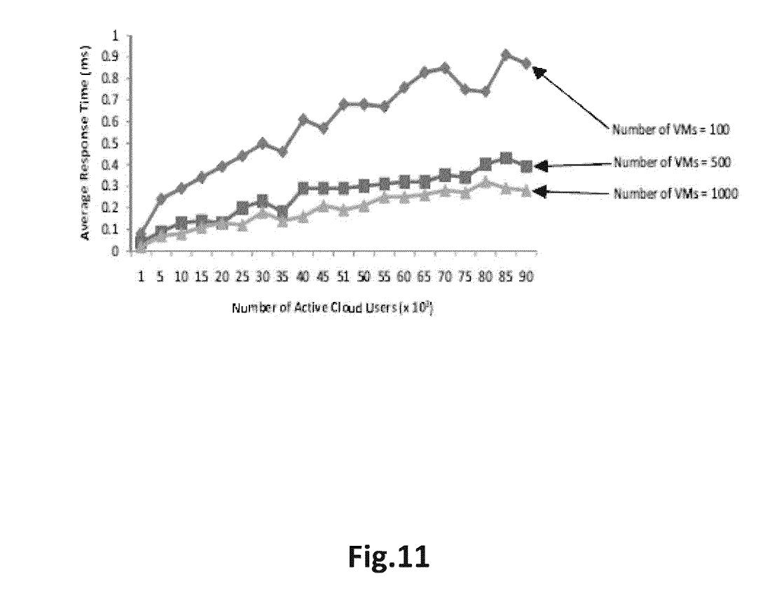

In the graph of FIG. 11, the value of r at 50% was fixed and the value of v was varied. It can be shown from FIG. 10 that increasing numbers of users will lead to an increase in the end-user perceived delay for all values of v. Fewer numbers of operational VMs led to additional waiting times for the users before they were granted access and therefore, resulted in longer delays. For N=100K, a 0.9 ms delay was observed with only 100 operational VMs, whereas a delay of 0.23 ms was observed for the same number of users and v=1000.

Experiments were conducted in a laboratory cloud setup, to evaluate the performance of EDoS detection and mitigation systems and methods described herein. Results obtained show that the systems and methods were able to detect and prevent attacks with reduced costs and overhead.

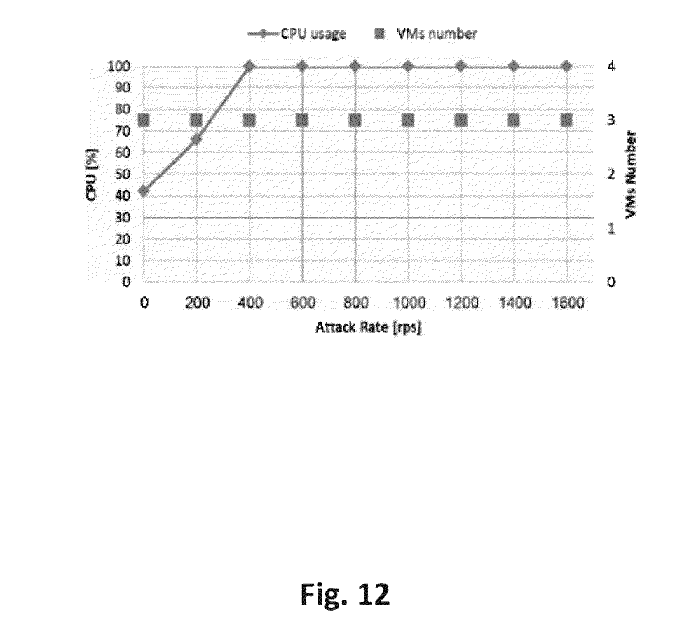

FIG. 12 is a graph illustrating the EDoS attack rate against CPU usage of cloud services. The results are without auto-scaling and mitigation technique. FIG. 12 illustrates a dramatic increase and continued CPU usage with an increased attack rate with the number of VMs kept constant.

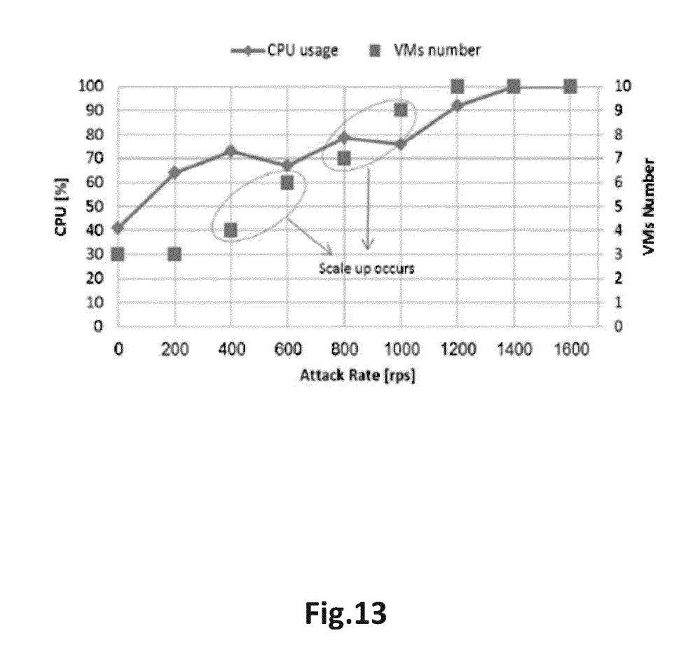

FIG. 13 is a graph illustrating the EDoS attack rate against CPU usage of cloud services with auto-scaling, but without mitigation technique. The CPU usage increased with an increase in attack rate, even with an increase in the number of VMs.

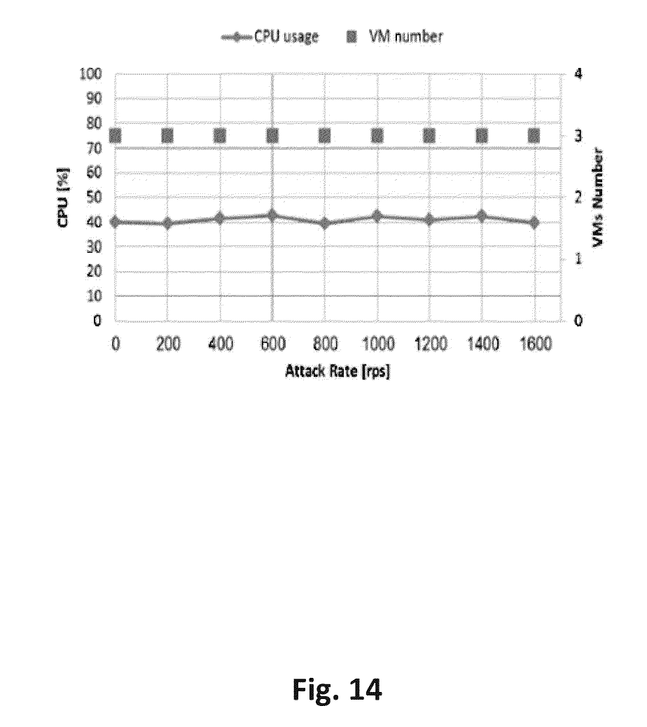

FIG. 14 is a graph illustrating the EDoS attack rate against CPU usage of cloud services with both auto-scaling and mitigation technique. Results illustrate a steady CPU usage using a steady number of VMs with an increased attack rate.

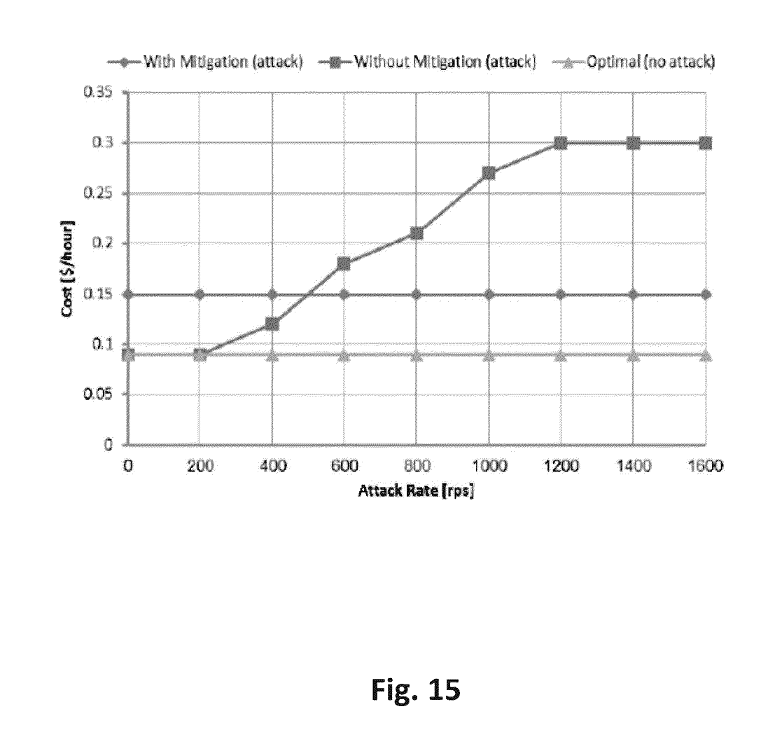

FIG. 15 is a graph illustrating experimental results of the cost of malicious attackers on cloud services. Costs remain steady using a mitigation technique with an increase in attack rate. However, the costs begin to rise at an attack rate of approximately 200 rps without using a mitigation technique. Costs also begin to even off at an attack rate of approximately 1200 rps.

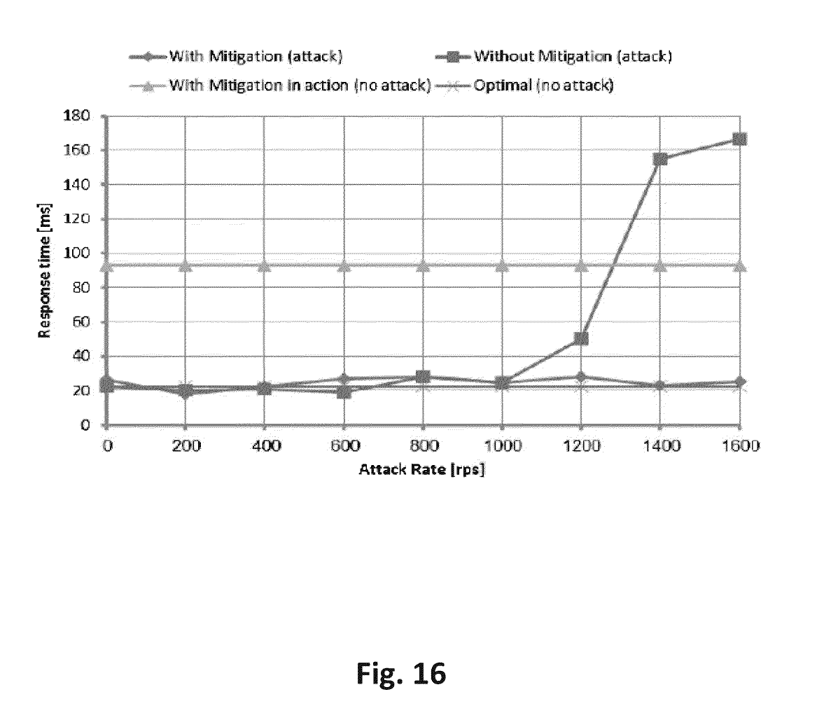

FIG. 16 is a graph illustrating experimental results which affect the response time. A high, but consistent response time was experienced using a mitigation technique in action with no attacks. The response time was low using a mitigation technique with attacks. The response time also remained low without a mitigation technique having attacks, but the response time began to rise at approximately 1000 rps.

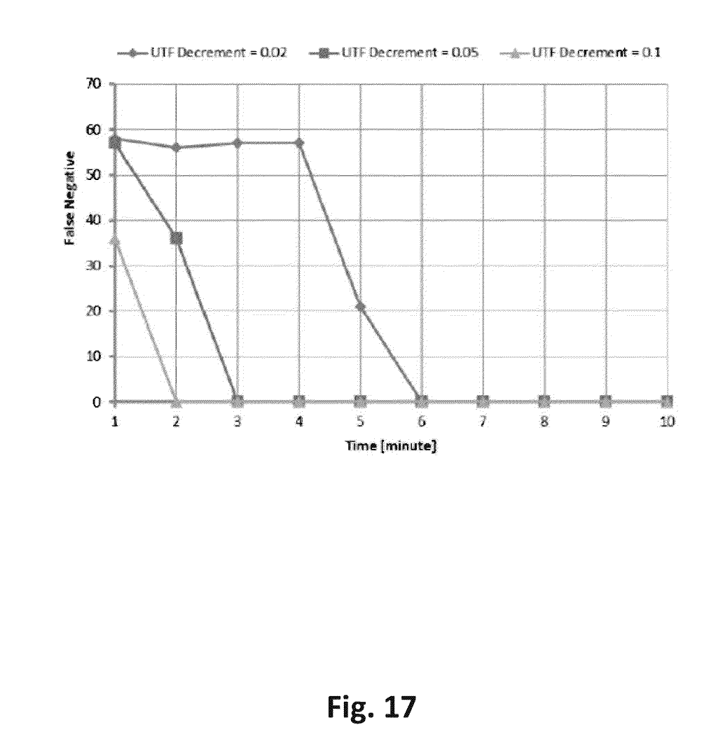

FIG. 17 is a graph illustrating experimental results of false negatives for one user at CRPS=1. The UTF decrements were varied at 0.02, 0.05, and 0.1. The number of false negatives decreased rapidly for a UTF decrement=01. At two minutes, the false negatives had essentially stopped. The number of false negatives also decreased rapidly for a UTF decrement=0.05, but the number of false negatives were initially higher and they subsided at approximately three minutes. For a UTF decrement of 0.02, the number of false negatives was initially high and did not begin to subside until approximately four minutes. The number of false negatives was essentially zero at approximately six minutes.

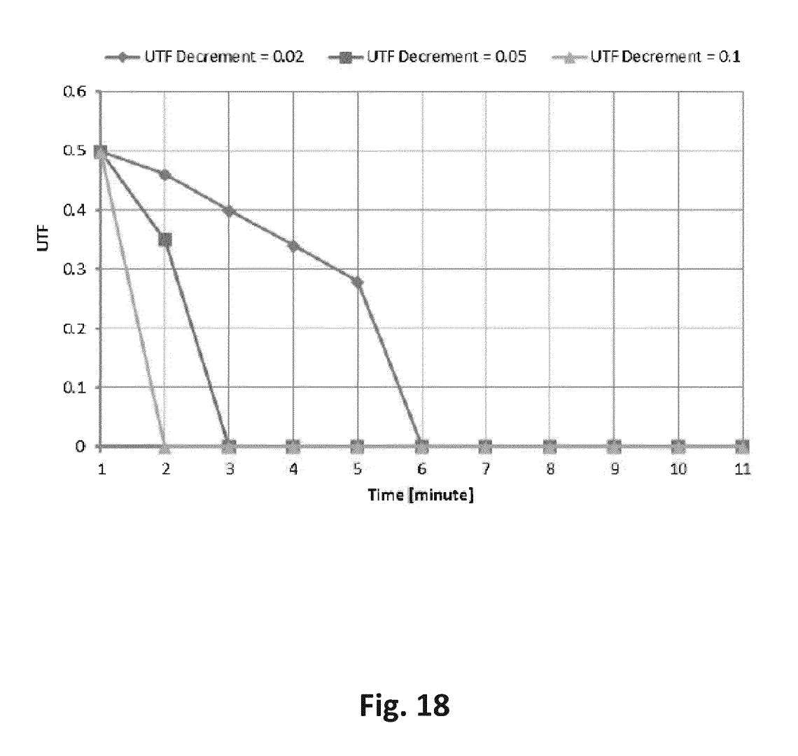

FIG. 18 is a graph illustrating experimental results for a constant UTF value and CRPS=1, and varied values of UTF decrement at 0.02, 0.05, and 0.1. Results illustrate a UTF decrement=0.1 decreased in UTF value the fastest, hitting essentially zero at approximately two minutes. A UTF decrement=0.05 caused the next faster UTF decrease, hitting essentially zero at approximately three minutes. A UTF decrement=0.02 decreased in UTF more slowly, and did not essentially hit zero until approximately six minutes.

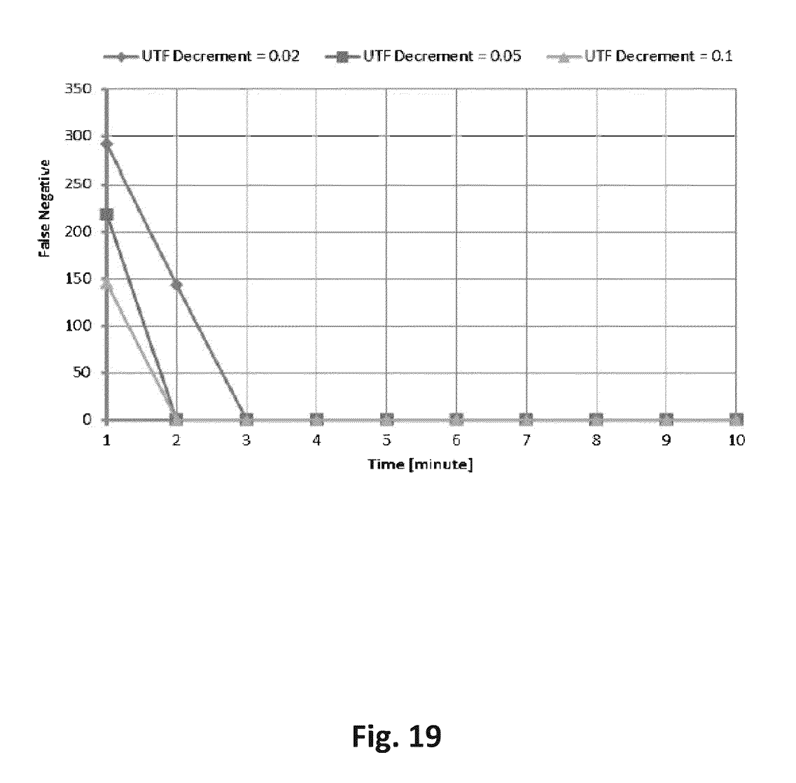

FIG. 19 is a graph illustrating experimental results for false negatives at CRPS=5 for varied values of UTF decrement at 0.02, 0.05, and 0.1. All three UTF decrement values caused a rapid decrease in false negatives. However, a UTF decrement=0.1 initially had the fewest number of false negatives, while a UTF decrement=0.02 initially had the highest number of false negatives.

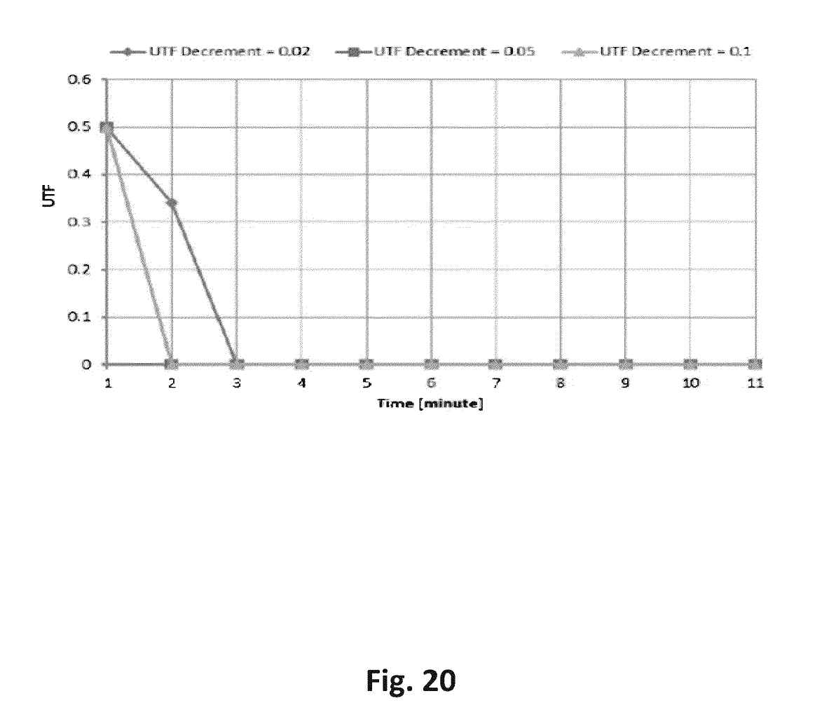

FIG. 20 is a graph illustrating experimental results for UTF values at CRPS=5 for varied UTF decrements of 0.02, 0.05, and 0.1. The UTF decrement values of 0.1 and 0.05 both decreased in UTF value rapidly, reaching essentially zero at two minutes. The UTF value for a UTF decrement=0.02 also decreased rapidly, reaching essentially zero at three minutes.

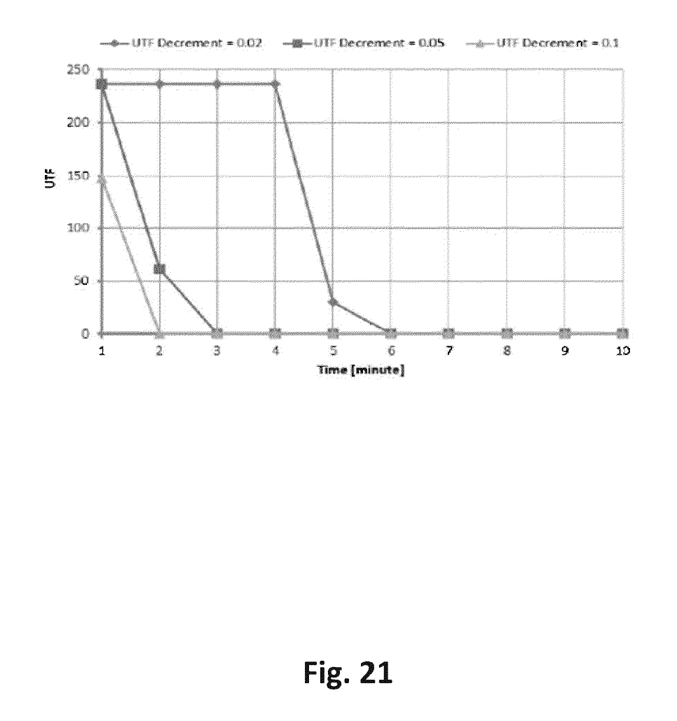

FIG. 21 is a graph illustrating experimental results of UTF values when an attacker sends fewer requests than allowed by the system at CRPS=5 for varied UTF decrement values of 0.02, 0.05, and 0.1. The UTF decrement values of 0.1 and 0.05 caused a rapid decrease in UTF value, reaching essentially zero at two and three minutes, respectively. However, the UTF value for a UTF decrement=0.02 did not decrease until four minutes, and essentially reached zero in UTF at approximately six minutes.

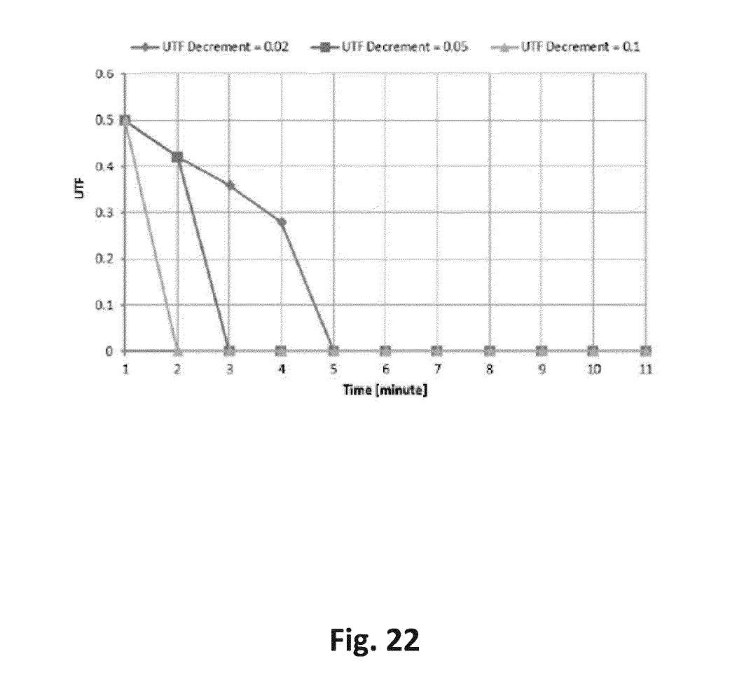

FIG. 22 is a graph illustrating experimental results of the UTF value when an attacker sends fewer requests than allowed by the system at CRPS=5 for varied UTF decrement values of 0.02, 0.05, and 0.1. All three UTF decrement values illustrate similar decreases in UTF value with the UTF decrement=0.1 reaching essentially a zero UTF value first at approximately two minutes, the UTF decrement=0.05 reaching essentially a zero UTF value second at approximately three minutes, and the UTF decrement=0.02 reaching essentially a zero UTF value third at approximately five minutes.

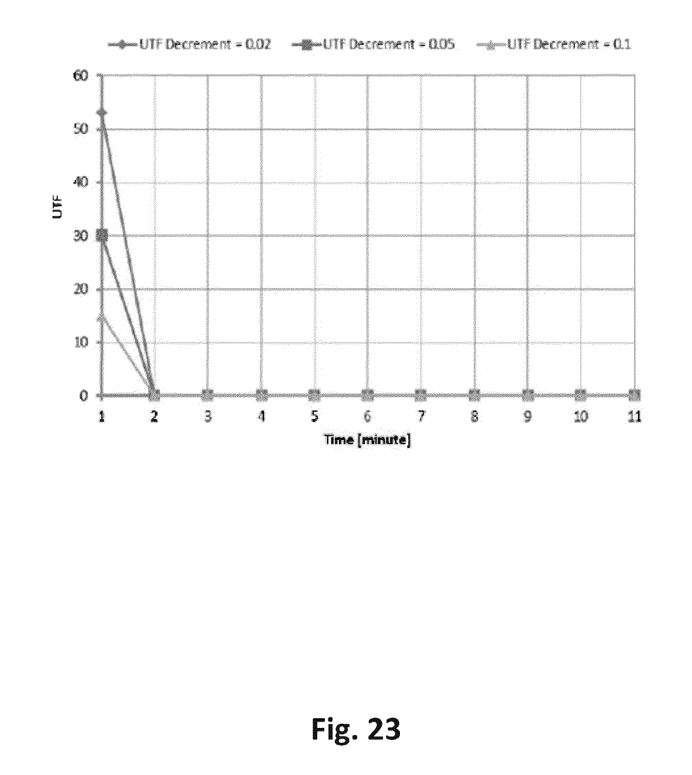

FIG. 23 is a graph illustrating experimental results of UTF values when an attacker sends more requests than allowed by the system at CRPS=5 for varied UTF decrement values of 0.02, 0.05, and 0.1. All three UTF decrement values caused a rapid decrease in UTF value, and UTF values for all three UTF decrement values reached essentially zero in approximately two minutes.

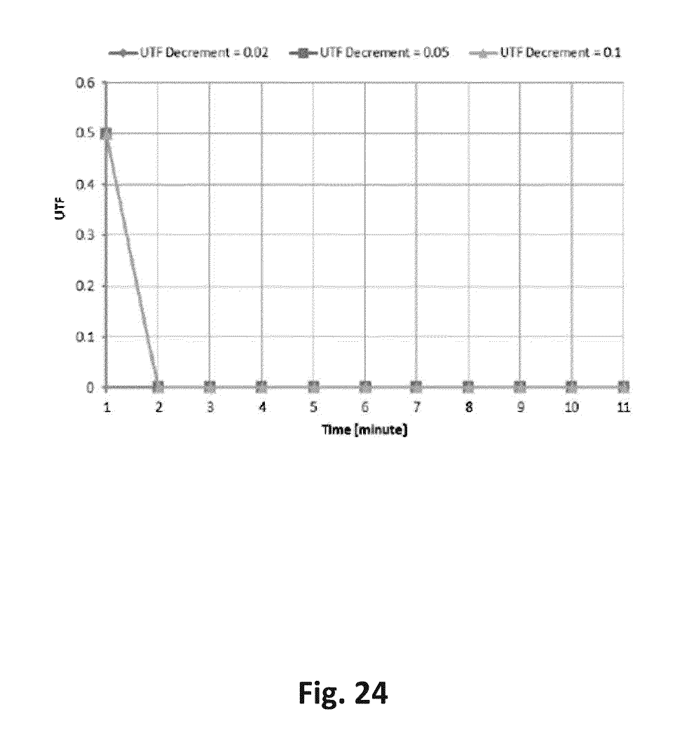

FIG. 24 is a graph illustrating experimental results of the UTF value when an attacker sends fewer requests than allowed by the system for CRPS=5 with varied UTF decrement values of 0.02, 0.05, and 0.1. Results of UTF values were essentially identical for all three UTF decrement values.

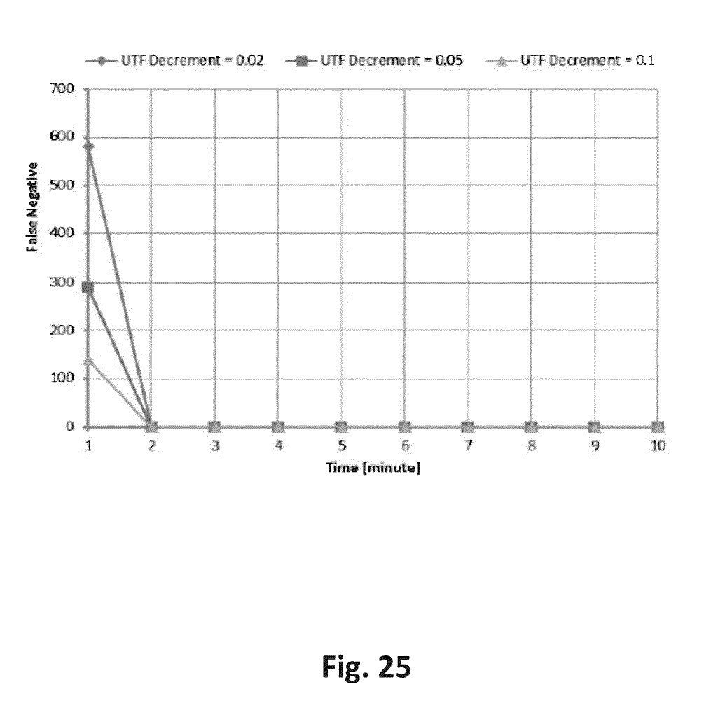

FIG. 25 is a graph illustrating experimental results of false negatives for CRPS=10 with varied UTF decrement values of 0.02, 0.05, and 0.1. The number of false negatives reached zero for all three UTF decrement values in approximately two minutes. However, a UTF decrement=0.1 initially had the lowest number of false negatives and a UTF decrement=0.02 initially had the highest number of false negatives.

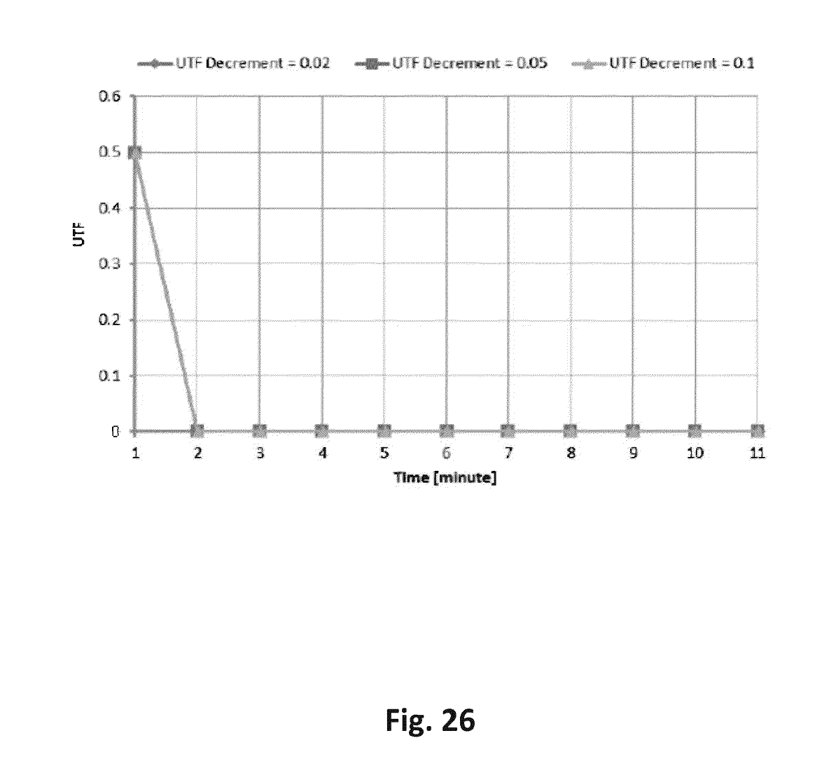

FIG. 26 is a graph illustrating experimental results of the UTF value with CRPS=10 for varied UTF decrement values of 0.02, 0.05, and 0.1. Results were essentially identical for all three UTF decrement values.

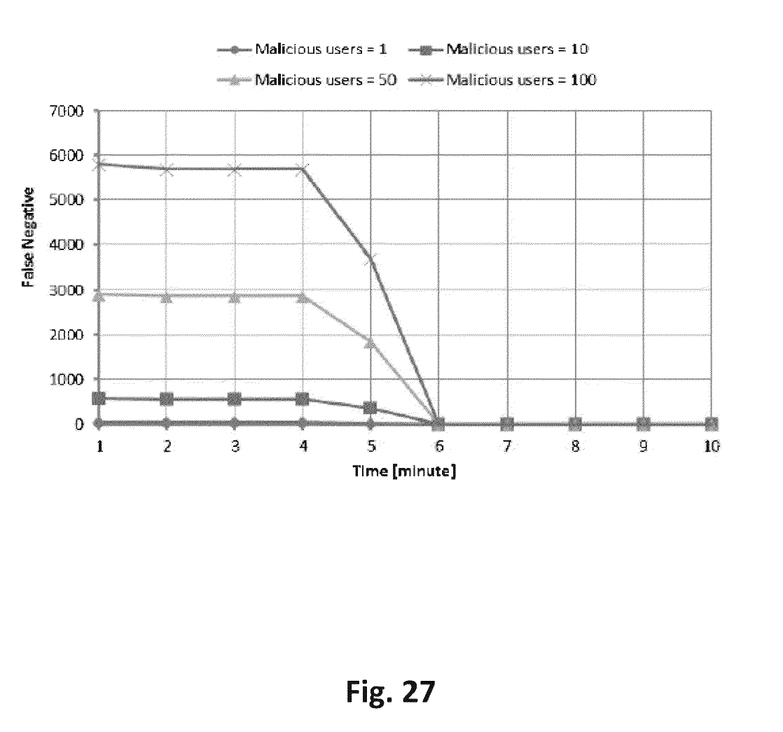

FIG. 27 is a graph illustrating experimental results of false negative results of multiple numbers of malicious users for groups of one, ten, fifty, and one hundred malicious users. One malicious user caused essentially zero false negatives over the entire test time of six minutes. Ten malicious users caused about 500 false negatives for about four minutes, then reached essentially zero at approximately six minutes. Fifty malicious users caused a markedly higher number of false negatives at just under 3000 for about four minutes, then reached essentially zero at approximately six minutes. One hundred malicious users caused the highest number of false negatives at just under 6000 for about four minutes, then reached essentially zero at approximately six minutes.

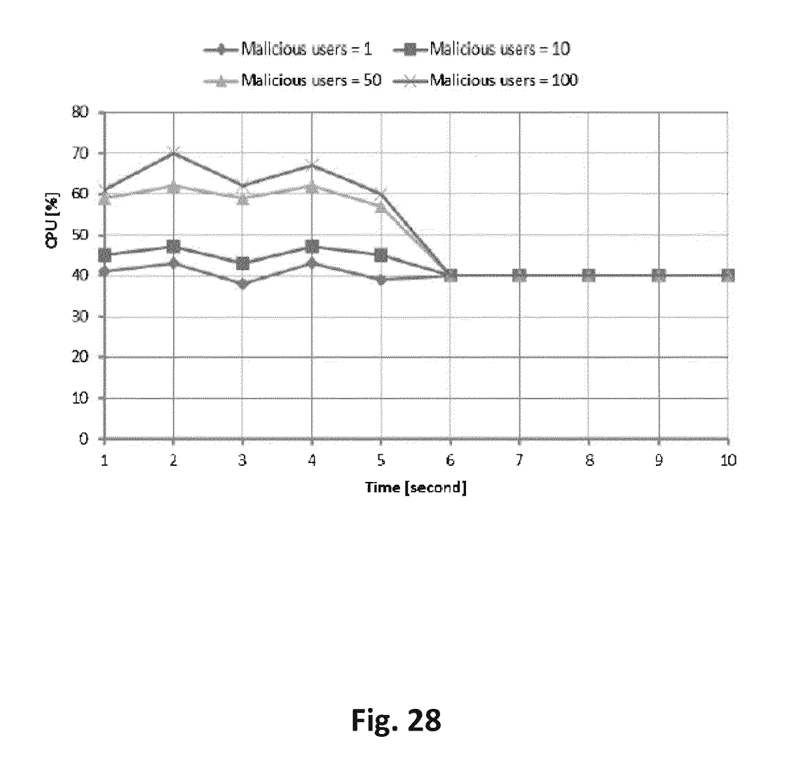

FIG. 28 is a graph illustrating the results of CPU usage from multiple malicious users for groups of one, ten, fifty, and one hundred malicious users. All four groups of malicious users produced similar results, with the groups of fifty and one hundred malicious users having a slightly higher CPU usage than the groups of one and ten malicious users. All four groups of malicious users reached a consistent CPU usage of about 40% at approximately six seconds.

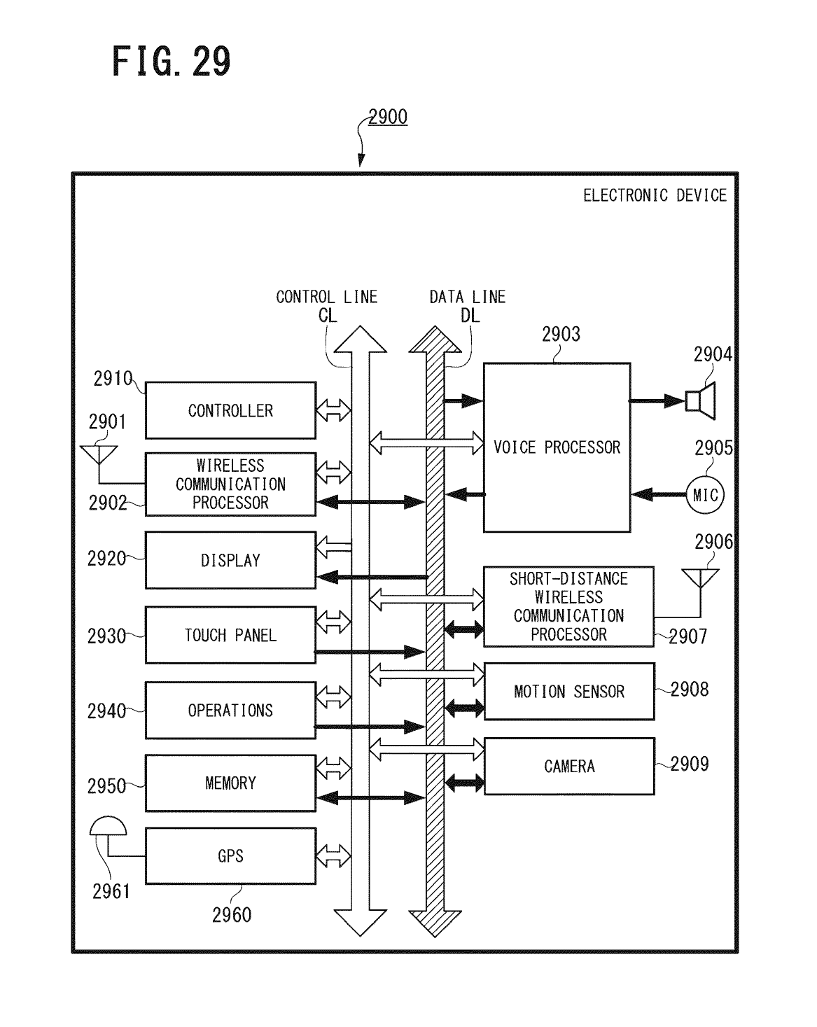

FIG. 29 is a block diagram illustrating an exemplary electronic device used in accordance with embodiments of the present disclosure. In the embodiments, electronic device 2900 can be a smartphone, a laptop, a tablet, a server, an e-reader, a camera, a navigation device, etc. Electronic device 2900 could be one or more of the devices used by users 220 in FIGS. 2-4. The exemplary electronic device 2900 of FIG. 29 includes a controller 2910 and a wireless communication processor 2902 connected to an antenna 2901. A speaker 2904 and a microphone 2905 are connected to a voice processor 2903.

The controller 2910 can include one or more Central Processing Units (CPUs), and can control each element in the electronic device 2900 to perform functions related to communication control, audio signal processing, control for the audio signal processing, still and moving image processing and control, and other kinds of signal processing. The controller 2910 can perform these functions by executing instructions stored in a memory 2950. Alternatively or in addition to the local storage of the memory 2950, the functions can be executed using instructions stored on an external device accessed on a network or on a non-transitory computer readable medium.

The memory 2950 includes but is not limited to Read Only Memory (ROM), Random Access Memory (RAM), or a memory array including a combination of volatile and non-volatile memory units. The memory 2950 can be utilized as working memory by the controller 2910 while executing the processes and algorithms of the present disclosure. Additionally, the memory 2950 can be used for long-term storage, e.g., of image data and information related thereto.

The electronic device 2900 includes a control line CL and data line DL as internal communication bus lines. Control data to/from the controller 2910 can be transmitted through the control line CL. The data line DL can be used for transmission of voice data, display data, etc.

The antenna 2901 transmits/receives electromagnetic wave signals between base stations for performing radio-based communication, such as the various forms of cellular telephone communication. The wireless communication processor 2902 controls the communication performed between the electronic device 2900 and other external devices via the antenna 2901. For example, the wireless communication processor 2902 can control communication between base stations for cellular phone communication.

The speaker 2904 emits an audio signal corresponding to audio data supplied from the voice processor 2903. The microphone 2905 detects surrounding audio and converts the detected audio into an audio signal. The audio signal can then be output to the voice processor 2903 for further processing. The voice processor 2903 demodulates and/or decodes the audio data read from the memory 2950 or audio data received by the wireless communication processor 2902 and/or a short-distance wireless communication processor 2907. Additionally, the voice processor 2903 can decode audio signals obtained by the microphone 2905.

The exemplary electronic device 2900 can also include a display 2920, a touch panel 2930, an operations key 2940, and a short-distance communication processor 2907 connected to an antenna 2906. The display 2920 can be a Liquid Crystal Display (LCD), an organic electroluminescence display panel, or another display screen technology. In addition to displaying still and moving image data, the display 2920 can display operational inputs, such as numbers or icons which can be used for control of the electronic device 2900. The display 2920 can additionally display a GUI for a user to control aspects of the electronic device 2900 and/or other devices. Further, the display 2920 can display characters and images received by the electronic device 2900 and/or stored in the memory 2950 or accessed from an external device on a network. For example, the electronic device 2900 can access a network such as the Internet and display text and/or images transmitted from a Web server.

The touch panel 2930 can include a physical touch panel display screen and a touch panel driver. The touch panel 2930 can include one or more touch sensors for detecting an input operation on an operation surface of the touch panel display screen. The touch panel 2930 also detects a touch shape and a touch area. Used herein, the phrase “touch operation” refers to an input operation performed by touching an operation surface of the touch panel display with an instruction object, such as a finger, thumb, or stylus-type instrument. In the case where a stylus or the like is used in a touch operation, the stylus can include a conductive material at least at the tip of the stylus such that the sensors included in the touch panel 930 can detect when the stylus approaches/contacts the operation surface of the touch panel display (similar to the case in which a finger is used for the touch operation).

According to aspects of the present disclosure, the touch panel 2930 can be disposed adjacent to the display 2920 (e.g., laminated) or can be formed integrally with the display 2920. For simplicity, the present disclosure assumes the touch panel 2930 is formed integrally with the display 2920 and therefore, examples discussed herein can describe touch operations being performed on the surface of the display 2920 rather than the touch panel 2930. However, the skilled artisan will appreciate that this is not limiting.

For simplicity, the present disclosure assumes the touch panel 2930 is a capacitance-type touch panel technology. However, it should be appreciated that aspects of the present disclosure can easily be applied to other touch panel types (e.g., resistance-type touch panels) with alternate structures. According to aspects of the present disclosure, the touch panel 930 can include transparent electrode touch sensors arranged in the X-Y direction on the surface of transparent sensor glass.

The touch panel driver can be included in the touch panel 2930 for control processing related to the touch panel 2930, such as scanning control. For example, the touch panel driver can scan each sensor in an electrostatic capacitance transparent electrode pattern in the X-direction and Y-direction and detect the electrostatic capacitance value of each sensor to determine when a touch operation is performed. The touch panel driver can output a coordinate and corresponding electrostatic capacitance value for each sensor. The touch panel driver can also output a sensor identifier that can be mapped to a coordinate on the touch panel display screen. Additionally, the touch panel driver and touch panel sensors can detect when an instruction object, such as a finger is within a predetermined distance from an operation surface of the touch panel display screen. That is, the instruction object does not necessarily need to directly contact the operation surface of the touch panel display screen for touch sensors to detect the instruction object and perform processing described herein. Signals can be transmitted by the touch panel driver, e.g. in response to a detection of a touch operation, in response to a query from another element based on timed data exchange, etc.

The touch panel 2930 and the display 2920 can be surrounded by a protective casing, which can also enclose the other elements included in the electronic device 2900. According to aspects of the disclosure, a position of the user's fingers on the protective casing (but not directly on the surface of the display 2920) can be detected by the touch panel 2930 sensors. Accordingly, the controller 2910 can perform display control processing described herein based on the detected position of the user's fingers gripping the casing. For example, an element in an interface can be moved to a new location within the interface (e.g., closer to one or more of the fingers) based on the detected finger position.

Further, according to aspects of the disclosure, the controller 2910 can be configured to detect which hand is holding the electronic device 2900, based on the detected finger position. For example, the touch panel 2930 sensors can detect a plurality of fingers on the left side of the electronic device 2900 (e.g., on an edge of the display 2920 or on the protective casing), and detect a single finger on the right side of the electronic device 2900. In this exemplary scenario, the controller 2910 can determine that the user is holding the electronic device 2900 with his/her right hand because the detected grip pattern corresponds to an expected pattern when the electronic device 2900 is held only with the right hand.

The operation key 2940 can include one or more buttons or similar external control elements, which can generate an operation signal based on a detected input by the user. In addition to outputs from the touch panel 2930, these operation signals can be supplied to the controller 2910 for performing related processing and control. According to aspects of the disclosure, the processing and/or functions associated with external buttons and the like can be performed by the controller 2910 in response to an input operation on the touch panel 2930 display screen rather than the external button, key, etc. In this way, external buttons on the electronic device 2900 can be eliminated in lieu of performing inputs via touch operations, thereby improving water-tightness.

The antenna 2906 can transmit/receive electromagnetic wave signals to/from other external apparatuses, and the short-distance wireless communication processor 2907 can control the wireless communication performed between the other external apparatuses. Bluetooth, IEEE 802.11, and near-field communication (NFC) are non-limiting examples of wireless communication protocols that can be used for inter-device communication via the short-distance wireless communication processor 2907.

The electronic device 2900 can include a motion sensor 2908. The motion sensor 2908 can detect features of motion (i.e., one or more movements) of the electronic device 2900. For example, the motion sensor 2908 can include an accelerometer to detect acceleration, a gyroscope to detect angular velocity, a geomagnetic sensor to detect direction, a geo-location sensor to detect location, etc., or a combination thereof to detect motion of the electronic device 2900. According to aspects of the disclosure, the motion sensor 2908 can generate a detection signal that includes data representing the detected motion. For example, the motion sensor 2908 can determine a number of distinct movements in a motion (e.g., from start of the series of movements to the stop, within a predetermined time interval, etc.), a number of physical shocks on the electronic device 2900 (e.g., a jarring, hitting, etc., of the electronic device 2900), a speed and/or acceleration of the motion (instantaneous and/or temporal), or other motion features. The detected motion features can be included in the generated detection signal. The detection signal can be transmitted, e.g., to the controller 2910, whereby further processing can be performed based on data included in the detection signal. The motion sensor 2908 can work in conjunction with a Global Positioning System (GPS) 2960. The GPS 2960 detects the present position of the electronic device 2900. The information of the present position detected by the GPS 2960 is transmitted to the controller 2910. An antenna 2961 is connected to the GPS 2960 for receiving and transmitting signals to and from a GPS satellite.

Electronic device 2900 can include a camera 2909, which includes a lens and shutter for capturing photographs of the surroundings around the electronic device 2900. In an embodiment, the camera 2909 captures surroundings of an opposite side of the electronic device 2900 from the user. The images of the captured photographs can be displayed on the display panel 2920. A memory saves the captured photographs. The memory can reside within the camera 2909 or it can be part of the memory 2950. The camera 2909 can be a separate feature attached to the electronic device 2900 or it can be a built-in camera feature.

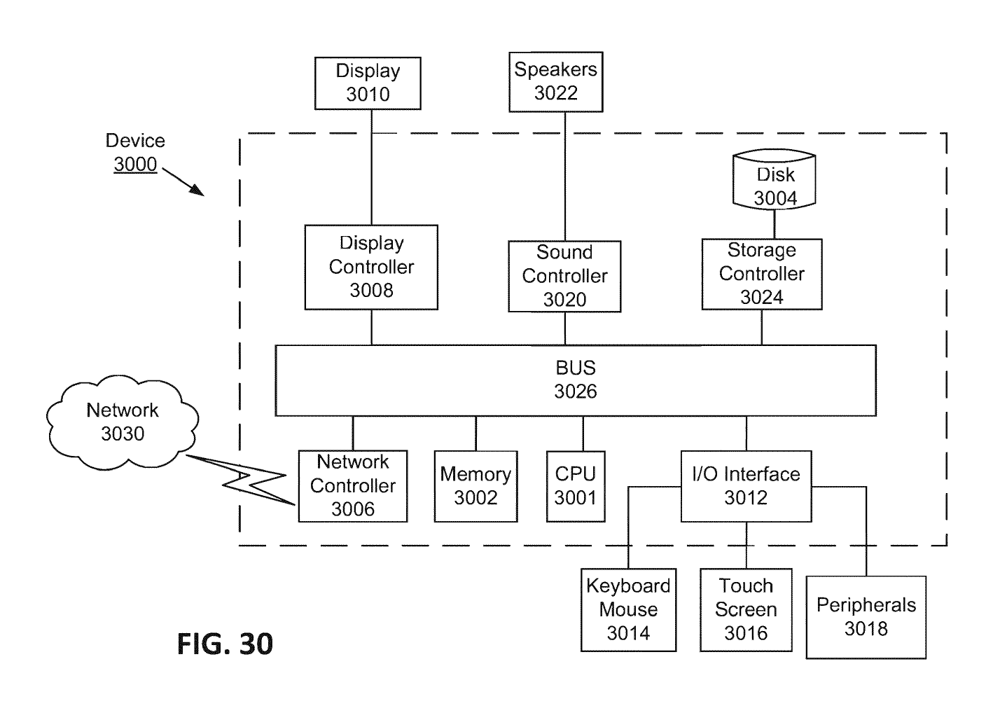

Next, a hardware description of an exemplary computing device 3000 used in accordance with some embodiments described herein is given with reference to FIG. 30. Features described above with reference to electronic device 2900 of FIG. 29 can be included in the computing device 3000 described herein. Computing device 3000 could be used as one or more of vFirewall node 210, VM Observer nodes 240, VM Investigator node 250, Job Scheduler 260, database 270, and load balancer node 280 of FIGS. 2-4.

In FIG. 30, the computing device 3000 includes a CPU 3001 which performs the processes described above and herein after. The process data and instructions can be stored in memory 3002. These processes and instructions can also be stored on a storage medium disk 3004 such as a hard drive (HDD) or portable storage medium or can be stored remotely. Further, the claimed features are not limited by the form of the computer-readable media on which the instructions of the process are stored. For example, the instructions can be stored on CDs, DVDs, in FLASH memory, RAM, ROM, PROM, EPROM, EEPROM, hard disk or any other information processing device with which the computing device 3000 communicates, such as a server or computer.

Further, the claimed features can be provided as a utility application, background daemon, or component of an operating system, or combination thereof, executing in conjunction with CPU 3001 and an operating system such as Microsoft Windows 7, UNIX, Solaris, LINUX, Apple MAC-OS and other systems known to those skilled in the art.

The hardware elements in order to achieve the computing device 3000 can be realized by various circuitry elements, known to those skilled in the art. For example, CPU 3001 can be a Xenon or Core processor from Intel of America or an Opteron processor from AMD of America, or can be other processor types that would be recognized by one of ordinary skill in the art. Alternatively, the CPU 3001 can be implemented on an FPGA, ASIC, PLD or using discrete logic circuits, as one of ordinary skill in the art would recognize. Further, CPU 3001 can be implemented as multiple processors cooperatively working in parallel to perform the instructions of the inventive processes described above and below.

The computing device 3000 in FIG. 30 also includes a network controller 3006, such as an Intel Ethernet PRO network interface card from Intel Corporation of America, for interfacing with network 3028. As can be appreciated, the network 3028 can be a public network, such as the Internet, or a private network such as an LAN or WAN network, or any combination thereof and can also include PSTN or ISDN sub-networks. The network 3028 can also be wired, such as an Ethernet network, or can be wireless such as a cellular network including EDGE, 3G and 4G wireless cellular systems. The wireless network can also be WiFi, Bluetooth, or any other wireless form of communication that is known.

The computing device 3000 further includes a display controller 3008, such as a NVIDIA GeForce GTX or Quadro graphics adaptor from NVIDIA Corporation of America for interfacing with display 3010, such as a Hewlett Packard HPL2445w LCD monitor. A general purpose I/O interface 3012 interfaces with a keyboard and/or mouse 3014 as well as a touch screen panel 3016 on or separate from display 3010. Touch screen panel 3016 includes features described above with reference to touch panel 2930 of FIG. 29. General purpose I/O interface 3012 also connects to a variety of peripherals 3018 including printers and scanners, such as an OfficeJet or DeskJet from Hewlett Packard.

A sound controller 3020 is also provided in the computing device 3000, such as Sound Blaster X-Fi Titanium from Creative, to interface with speakers/microphone 3022 thereby providing sounds and/or music.

The general purpose storage controller 3024 connects the storage medium disk 3004 with communication bus 3026, which can be an ISA, EISA, VESA, PCI, or similar, for interconnecting all of the components of the computing device 3000. A description of the general features and functionality of the display 3010, keyboard and/or mouse 3014, as well as the display controller 3008, storage controller 3024, network controller 3006, sound controller 3020, and general purpose I/O interface 3012 is omitted herein for brevity as these features are known.

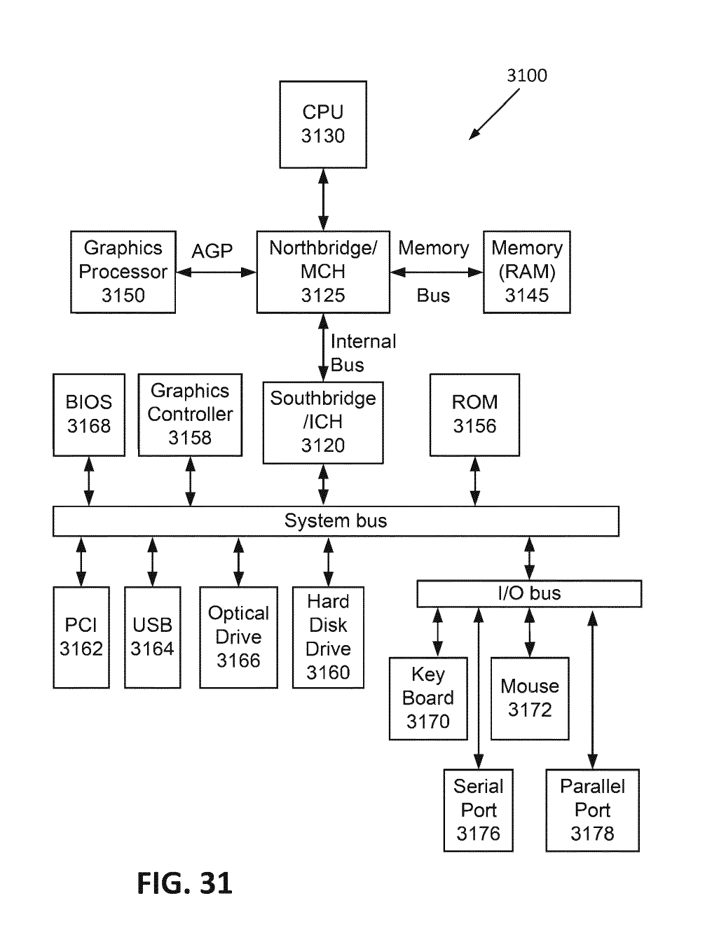

The exemplary circuit elements described in the context of the present disclosure can be replaced with other elements and structured differently than the examples provided herein. Moreover, circuitry configured to perform features described herein can be implemented in multiple circuit units (e.g., chips), or the features can be combined in circuitry on a single chipset, as shown on FIG. 31. The chipset of FIG. 31 can be implemented in conjunction with either electronic device 2900 or computing device 3000 described above with reference to FIGS. 29 and 30, respectively.

FIG. 31 shows a schematic diagram of a data processing system, according to aspects of the disclosure described herein for performing menu navigation, as described above. The data processing system is an example of a computer in which code or instructions implementing the processes of the illustrative embodiments can be located.

In FIG. 31, data processing system 3100 employs an application architecture including a north bridge and memory controller application (NB/MCH) 3125 and a south bridge and input/output (I/O) controller application (SB/ICH) 3120. The central processing unit (CPU) 3130 is connected to NB/MCH 3125. The NB/MCH 3125 also connects to the memory 3145 via a memory bus, and connects to the graphics processor 3150 via an accelerated graphics port (AGP). The NB/MCH 3125 also connects to the SB/ICH 3120 via an internal bus (e.g., a unified media interface or a direct media interface). The CPU 3130 can contain one or more processors and even can be implemented using one or more heterogeneous processor systems.

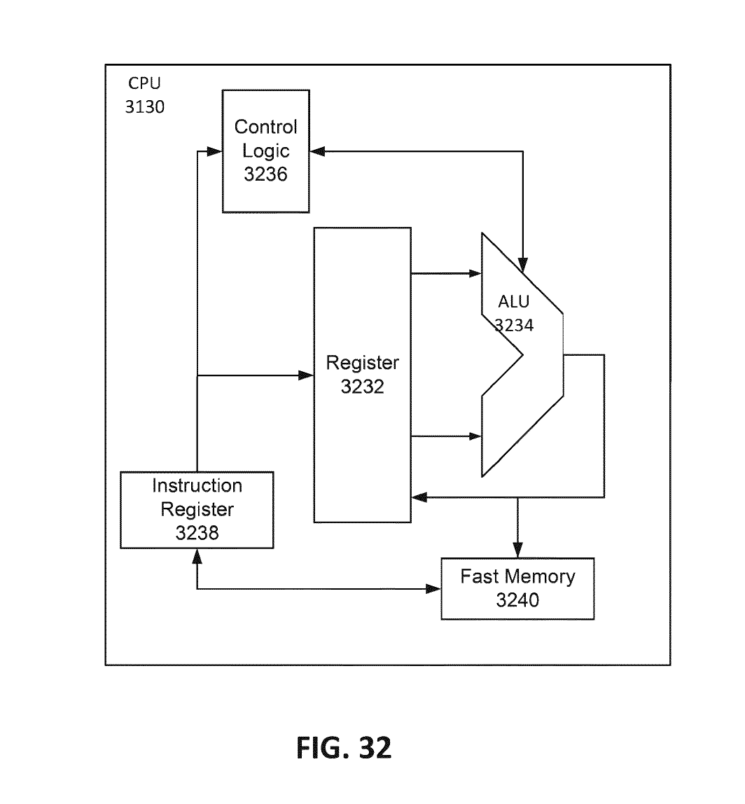

For example, FIG. 32 shows one implementation of CPU 3130. In one implementation, an instruction register 3238 retrieves instructions from a fast memory 3240. At least part of these instructions are fetched from an instruction register 3238 by a control logic 3236 and interpreted according to the instruction set architecture of the CPU 3130. Part of the instructions can also be directed to a register 3232. In one implementation the instructions are decoded according to a hardwired method, and in another implementation the instructions are decoded according to a microprogram that translates instructions into sets of CPU configuration signals that are applied sequentially over multiple clock pulses. After fetching and decoding the instructions, the instructions are executed using an arithmetic logic unit (ALU) 3234 that loads values from the register 3232 and performs logical and mathematical operations on the loaded values according to the instructions. The results from these operations can be fed back into the register 3232 and/or stored in a fast memory 3240. According to aspects of the disclosure, the instruction set architecture of the CPU 3130 can use a reduced instruction set computer (RISC), a complex instruction set computer (CISC), a vector processor architecture, or a very long instruction word (VLIW) architecture. Furthermore, the CPU 3130 can be based on the Von Neuman model or the Harvard model. The CPU 3130 can be a digital signal processor, an FPGA, an ASIC, a PLA, a PLD, or a CPLD. Further, the CPU 3130 can be an x86 processor by Intel or by AMD; an ARM processor; a Power architecture processor by, e.g., IBM; a SPARC architecture processor by Sun Microsystems or by Oracle; or other known CPU architectures.

Referring again to FIG. 31, the data processing system 3100 can include the SB/ICH 3120 being coupled through a system bus to an I/O Bus, a read only memory (ROM) 3156, universal serial bus (USB) port 3164, a flash binary input/output system (BIOS) 3168, and a graphics controller 3158. PCI/PCIe devices can also be coupled to SB/ICH 3120 through a PCI bus 3162.

The PCI devices can include, for example, Ethernet adapters, add-in cards, and PC cards for notebook computers. The Hard disk drive 3160 and CD-ROM 2966 can use, for example, an integrated drive electronics (IDE) or serial advanced technology attachment (SATA) interface. In one implementation the I/O bus can include a super I/O (SIO) device.

Further, the hard disk drive (HDD) 3160 and optical drive 3166 can also be coupled to the SB/ICH 3120 through a system bus. In one implementation, a keyboard 3170, a mouse 3172, a parallel port 3178, and a serial port 3176 can be connected to the system bus through the I/O bus. Other peripherals and devices can be connected to the SB/ICH 3120 using a mass storage controller such as SATA or PATA, an Ethernet port, an ISA bus, a LPC bridge, SMBus, a DMA controller, and an Audio Codec.

Moreover, the present disclosure is not limited to the specific circuit elements described herein, nor is the present disclosure limited to the specific sizing and classification of these elements. For example, the skilled artisan will appreciate that the circuitry described herein may be adapted based on changes on battery sizing and chemistry, or based on the requirements of the intended back-up load to be powered.

The functions and features described herein can also be executed by various distributed components of a system. For example, one or more processors can execute these system functions, wherein the processors are distributed across multiple components communicating in a network. The distributed components can include one or more client and server machines, which can share processing, such as a cloud computing system, in addition to various human interface and communication devices (e.g., display monitors, smart phones, tablets, personal digital assistants (PDAs)). The network can be a private network, such as a LAN or WAN, or can be a public network, such as the Internet. Input to the system can be received via direct user input and received remotely either in real-time or as a batch process. Additionally, some implementations can be performed on modules or hardware not identical to those described. Accordingly, other implementations are within the scope that can be claimed.

The functions and features described herein may also be executed by various distributed components of a system. For example, one or more processors may execute these system functions, wherein the processors are distributed across multiple components communicating in a network. For example, distributed performance of the processing functions can be realized using grid computing or cloud computing. Many modalities of remote and distributed computing can be referred to under the umbrella of cloud computing, including: software as a service, platform as a service, data as a service, and infrastructure as a service. Cloud computing generally refers to processing performed at centralized locations and accessible to multiple users who interact with the centralized processing locations through individual terminals.

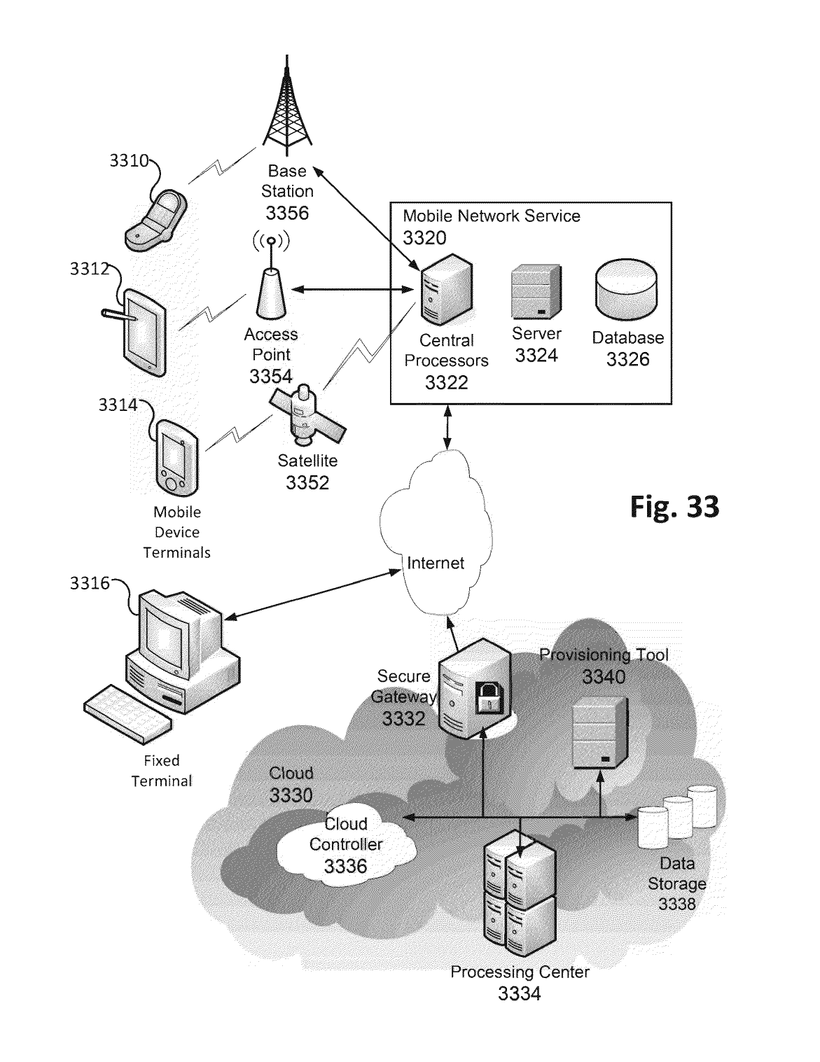

FIG. 33 illustrates an exemplary cloud computing system, wherein users such as users 220 access the cloud through mobile device terminals or fixed terminals that are connected to the Internet. One or more of vFirewall node 210, VM Observer nodes 240, VM Investigator node 250, Job Scheduler 260, database 270, and load balancer node 280 of FIGS. 2-4 could be used in the cloud computing system illustrated in FIG. 33.

The mobile device terminals can include a cell phone 3310, a tablet computer 3312, and a smartphone 3314, for example. The mobile device terminals can connect to a mobile network service 3320 through a wireless channel such as a base station 3356 (e.g., an Edge, 3G, 4G, or LTE Network), an access point 3354 (e.g., a femto cell or WiFi network), or a satellite connection 3352. In one implementation, signals from the wireless interface to the mobile device terminals (e.g., the base station 3356, the access point 3354, and the satellite connection 3352) are transmitted to a mobile network service 3320, such as an EnodeB and radio network controller, UMTS, or HSDPA/HSUPA. Mobile users' requests and information are transmitted to central processors 3322 that are connected to servers 3324 to provide mobile network services, for example. Further, mobile network operators can provide service to mobile users for authentication, authorization, and accounting based on home agent and subscribers' data stored in databases 3326, for example. The subscribers' requests are subsequently delivered to a cloud 3330 through the Internet.

A user can also access the cloud through a fixed terminal 3316, such as a desktop or laptop computer or workstation that is connected to the Internet via a wired network connection or a wireless network connection. The mobile network service 3320 can be a public or a private network such as an LAN or WAN network. The mobile network service 3320 can be wireless such as a cellular network including EDGE, 3G and 4G wireless cellular systems. The wireless mobile network service 3320 can also be Wi-Fi, Bluetooth, or any other wireless form of communication that is known.

The user's terminal, such as a mobile user terminal and a fixed user terminal, provides a mechanism to connect via the Internet to the cloud 3330 and to receive output from the cloud 3330, which is communicated and displayed at the user's terminal. In the cloud 3330, a cloud controller 3336 processes the request to provide users with the corresponding cloud services. These services are provided using the concepts of utility computing, virtualization, and service-oriented architecture.

In one implementation, the cloud 3330 is accessed via a user interface such as a secure gateway 3332. The secure gateway 3332 can for example, provide security policy enforcement points placed between cloud service consumers and cloud service providers to interject enterprise security policies as the cloud-based resources are accessed. Further, the secure gateway 3332 can consolidate multiple types of security policy enforcement, including for example, authentication, single sign-on, authorization, security token mapping, encryption, tokenization, logging, alerting, and API control. The cloud 3330 can provide to users, computational resources using a system of virtualization, wherein processing and memory requirements can be dynamically allocated and dispersed among a combination of processors and memories to create a virtual machine that is more efficient at utilizing available resources. Virtualization creates an appearance of using a single seamless computer, even though multiple computational resources and memories can be utilized according to increases or decreases in demand. In one implementation, virtualization is achieved using a provisioning tool 3340 that prepares and equips the cloud resources, such as the processing center 3334 and data storage 3338 to provide services to the users of the cloud 3330. The processing center 3334 can be a computer cluster, a data center, a main frame computer, or a server farm. In one implementation, the processing center 3334 and data storage 3338 are collocated.

Embodiments described herein can be implemented in conjunction with one or more of the devices described above with reference to FIGS. 29-33. Embodiments are a combination of hardware and software, and circuitry by which the software is implemented.

An embodiment includes an EDoS mitigation system, including a firewall node configured with circuitry to filter incoming traffic from one or more users and to maintain a table of IP addresses of suspected users. The EDoS mitigation system also includes an investigator computing device configured with circuitry to monitor legitimacy of the one or more users forwarded from the firewall node when an incoming IP address matches a listed IP address within the table of IP addresses or when a threshold rate of requests for access to cloud services of the incoming IP address is exceeded. The investigator computing device implements a rate limit control at which a given user can request access to the cloud services based on concurrent requests per second (CRPS), a random check (RC), and a user trust factor (UTF). The EDoS mitigation system also includes a load balancer computing device configured with circuitry to schedule jobs received from the firewall node or the investigator computing device and to automatically scale incoming requests for access to the cloud services when the threshold is exceeded. The EDoS mitigation system also includes a database having a rate limit table for tracking past behavior of the one or more users and a copy of the table of IP addresses of suspected users. The EDoS mitigation system also includes one or more observer devices, each configured to probe local resource usage of one or more associated computing devices and to redirect subsequent requests for access to the cloud services to the investigator computing device when network link utilization, CPU utilization, or memory allocation usage has been exceeded.

In the EDoS mitigation system, the CRPS can include a value of an upper limit on a number of requests permitted from a single IP address arriving within one second. The RC can include a random value selected between one and a total requests per minute (TRPM) value. The rate limit table can include one or more fields of an IP address field, a last activity time stamp field, a requests count field, a UTF field, and a count field.

The UTF can include a value calculated by the investigator computing device to periodically check an IP address via a Turing test. The UTF value can be decremented a first amount for an incorrect answer from the Turing test, and the UTF value can be incremented a second amount for a correct answer from the Turing test. The IP address can be forwarded to the firewall node to be included in the table of IP addresses of suspected users when a cumulative UTF value is below a minimum UTF value.

FIG. 5 illustrated an exemplary algorithmic flowchart for executing an EDoS detection and mitigation process. The process includes determining whether a CRPS value has been breached in a number of requests for access to cloud services by an IP address, and dropping the requests for access when the CRPS value has been breached and a UTF value is below a minimum UTF value. The process also includes determining whether the number of requests matches a RC value when the CRPS value has not been breached. The process also includes implementing a Turing test when any of the following events occur: a) the number of requests matches the RC value, b) the number of requests does not match the RC value but the UTF value is below the minimum UTF value, or c) the CRPS value has been breached but the UTF value is not below the minimum UTF value. Steps of the process are implemented via an investigator computing device configured by circuitry to monitor legitimacy of IP addresses forwarded from a firewall node and to implement a rate limit control at which a given user can request access to the cloud services based on the CRPS value, the RC value, and the UTF value.

The process of FIG. 5 can also include incrementing the UTF value by a first amount when the given user passes the Turing test, and decrementing the UTF value by a second amount when the given user fails the Turing test, wherein the second amount can be greater than the first amount. The process can also include dropping the requests when a cumulative UTF value falls below the minimum UTF value, and granting access to cloud services when the cumulative UTF value is above the minimum UTF value. The CRPS can include a value of an upper limit on a number of requests permitted from a single IP address arriving within one second. The RC value can include a random value selected between one and a TRPM value. The UTF value can include a value calculated by the investigator computing device to periodically check an IP address via the Turing test.

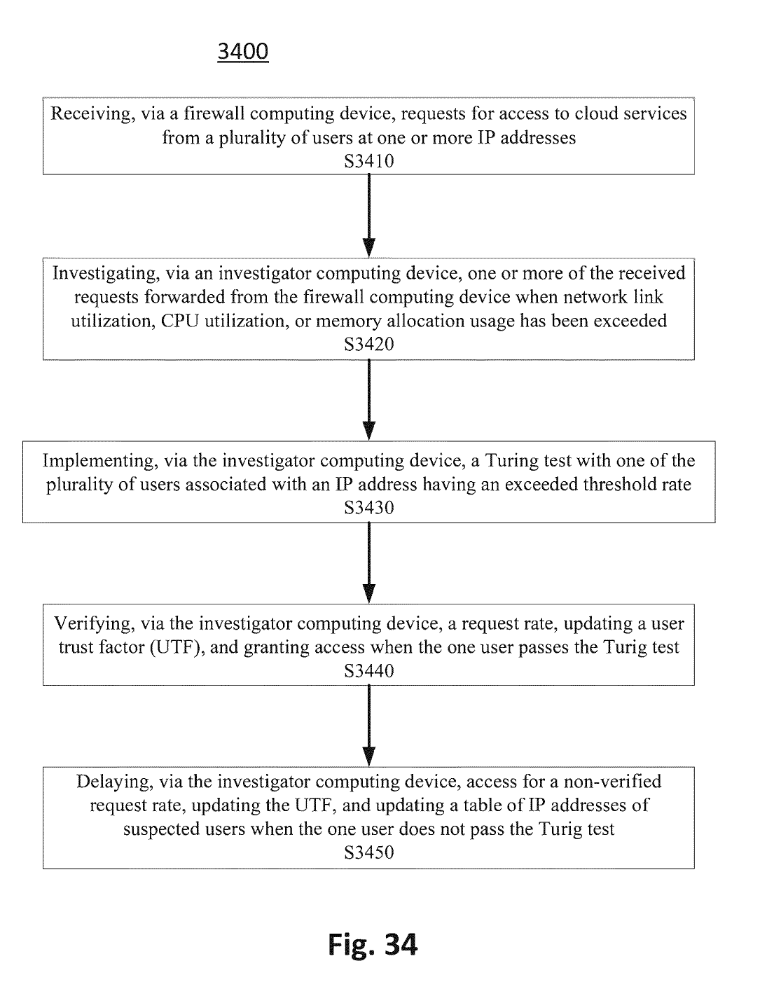

FIG. 34 illustrates an exemplary algorithmic flowchart for performing a method 3400 of mitigating an EDoS according to one aspect of the present disclosure. The hardware description above, exemplified by any one of the structural examples shown in FIG. 29, 30, or 31, constitutes or includes specialized corresponding structure that is programmed or configured to perform the algorithm shown in FIG. 34, as well as the algorithm illustrated in FIG. 5. For example, the algorithm shown in FIG. 5 and/or FIG. 34 may be completely performed by the circuitry included in the single device shown in FIG. 29 or 30, or the chipset as shown in FIG. 31, or the algorithms may be completely performed in a shared manner distributed over the circuitry of any plurality of the devices shown in FIG. 33.

Method 3400 includes receiving requests for access to cloud services from a plurality of users at one or more IP addresses, via a firewall computing device in step S3410. Method 3400 also includes investigating one or more of the received requests forwarded from an observer computing device when a threshold rate of requests for access is exceeded, via an investigator computing device in step S3420. Method 3400 also includes implementing a Turing test with one of the plurality of users associated with an IP address having an exceeded threshold rate, via the investigator computing device in step S3430. Method 3400 also includes verifying a request rate, updating a UTF, and granting access when the one user passes the Turing test, via the investigator computing device in step S3440. Method 3400 also includes delaying access for a non-verified request rate, updating the UTF, and updating a table of IP addresses of suspected users when the one user does not pass the Turing test, via the investigator computing device in step S3450.

Method 3400 can also include scheduling jobs received from the firewall computing device or the investigator computing device and automatically scaling incoming requests for access to cloud services when the threshold is exceeded, via a job scheduler. Method 3400 can also include determining whether a CRPS value has been breached in the requests for access to cloud services by a given IP address. Method 3400 can also include dropping the requests for access to cloud services when the CRPS value has been breached and the UTF is below a minimum UTF value for the given IP address. The observer computing device can be configured with circuitry to probe local resource usage of one or more associated computing devices and to redirect subsequent requests for cloud services access to the investigator computing device when network link utilization, CPU utilization, or memory allocation usage has been exceeded.

Embodiments described herein provide fair control for cloud resource access by end-users in the event of an EDoS attack. Controlled access guarantees can be provided to all cloud users, based on their past behavior. Systems and methods include a VM Observer node, vFirewall node, and VM Investigator node, operating hand in hand, to control access to the end-users, for mitigating the effects of an EDoS attack. Resource-usage thresholds are specified at each VM node and probed constantly by a VM Observer process. The VM Investigator node is triggered in response to excessive resource usage or if blacklisted requests arrive at the vFirewall node. The VM Investigator node provides controlled access to all users.

Through embodiments described herein, none of the requests that surpass the defined thresholds of resource usage are dropped. Instead, the users are provided with a delayed access to the cloud services based on system parameters, as well as past user behavior (based on the UTF value). By analyzing the results obtained from simulation of the systems and methods described herein, it is evident that the effect of the EDoS attack is mitigated when access to cloud resources is controlled over a stretch of time. Moreover, the user perceived delays imposed through the systems and methods described herein were found to be minimal.

Cloud computing is a paradigm that provides scalable IT resources as a service over the Internet. Embodiments described herein provide a reactive approach for protecting IT resources of a cloud infrastructure against malicious network-based attacks launched by an adversary class.

Systems and methods described herein help increase the revenue of the organization by cutting down on expenditures associated with unwanted use/misuse of cloud resources available on site. During an EDoS attack, the existing back-end IT resources of an organization are utilized beyond the norms. As a result, not only are resources exhausted which require intervention by IT support staff for resetting the equipment, but a cost overhead is imposed on end-users, who will inadvertently bare the expenses associated with such an attack. The reputation of the cloud service provider is also at stake during such malicious attacks.

The foregoing discussion discloses and describes merely exemplary embodiments of the present disclosure. As will be understood by those skilled in the art, the present disclosure may be embodied in other specific forms without departing from the spirit or essential characteristics thereof. Accordingly, the present disclosure is intended to be illustrative and not limiting thereof. The disclosure, including any readily discernible variants of the teachings herein defines in part, the scope of the foregoing claim terminology.

1. An Economic Denial of Sustainability (EDoS) mitigation system, comprising:
a firewall node configured with circuitry to filter incoming traffic from one or more users and to maintain a table of IP addresses of suspected users;
an investigator computing device configured with circuitry to monitor legitimacy of the one or more users forwarded from the firewall node when an incoming IP address matches a listed IP address within the table of IP addresses, wherein the investigator computing device implements a rate limit control at which a given user can request access to the cloud services based on concurrent requests per second (CRPS), a random check (RC), and a user trust factor (UTF);
a load balancer computing device configured with circuitry to schedule jobs received from the firewall node or the investigator computing device and to automatically scale incoming requests for access to the cloud services when the threshold is exceeded;
a database having a rate limit table for tracking past behavior of the one or more users and a copy of the table of IP addresses of suspected users; and
one or more observer devices, each configured to probe local resource usage of one or more associated computing devices and to update the firewall node to redirect subsequent requests for access to the cloud services to the investigator computing device when network link utilization, CPU utilization, or memory allocation usage has been exceeded.

2. The EDoS mitigation system of claim 1, wherein the CRPS includes a value of an upper limit on a number of requests permitted from a single IP address arriving within one second.

3. The EDoS mitigation system of claim 1, wherein the RC includes a random value selected between one and a total requests per minute (TRPM) value.

4. The EDoS mitigation system of claim 1, wherein the rate limit table includes one or more fields of an IP address field, a last activity time stamp field, a requests count field, a UTF field, and a count field.

5. The EDoS mitigation system of claim 1, wherein the UTF includes a value calculated by the investigator computing device to periodically check an IP address via a Turing test.

6. The EDoS mitigation system of claim 5, wherein the UTF value is decremented a first amount for an incorrect answer from the Turing test, and the UTF value is incremented a second amount for a correct answer from the Turing test.

7. The EDoS mitigation system of claim 6, wherein the IP address is forwarded to the firewall node to be included in the table of IP addresses of suspected users when a cumulative UTF value is below a minimum UTF value.

8. A method of mitigating an Economic Denial of Sustainability (EDoS), the method comprising:
determining whether a concurrent requests per second (CRPS) value has been breached in a number of requests for access to cloud services by an IP address;
dropping the requests for access when the CRPS value has been breached and a user trust factor (UTF) value is below a minimum UTF value;
determining whether the number of requests matches a random check (RC) value when the CRPS value has not been breached; and
implementing a Turing test when any of the following events occur: a) the number of requests matches the RC value, b) the request number does not match the RC value but the UTF value is below the minimum UTF value, or c) the CRPS value has been breached but the UTF value is not below the minimum UTF value, wherein steps of the method are implemented via an investigator computing device configured by circuitry to monitor legitimacy of IP addresses forwarded from a firewall node and to implement a rate limit control at which a given user can request access to the cloud services based on the CRPS value, the RC value, and the UTF value.

9. The method of claim 8, further comprising:
incrementing the UTF value by a first amount when the given user passes the Turing test; and
decrementing the UTF value by a second amount when the given user fails the Turing test.

10. The method of claim 9, wherein the second amount is greater than the first amount.

11. The method of claim 9, further comprising:
dropping the requests when a cumulative UTF value falls below the minimum UTF value.

12. The method of claim 11, further comprising:
granting access to cloud services when the cumulative UTF value is above the minimum UTF value.

13. The method of claim 8, wherein the CRPS includes a value of an upper limit on a number of requests permitted from a single IP address arriving within one second.

14. The method of claim 8, wherein the RC value includes a random value selected between one and a total requests per minute (TRPM) value.

15. The method of claim 8, wherein the UTF value includes a value calculated by the investigator computing device to periodically check an IP address via the Turing test.

16. A method of mitigating an Economic Denial of Sustainability (EDoS), the method comprising:
receiving, via a firewall computing device, requests for access to cloud services from a plurality of users at one or more IP addresses;
investigating, via an investigator computing device, one or more of the received requests forwarded from the firewall computing device when network link utilization, CPU utilization, or memory allocation usage has been exceeded;
implementing, via the investigator computing device, a Turing test with one of the plurality of users associated with an IP address having an exceeded threshold rate;
verifying, via the investigator computing device, a request rate, updating a user trust factor (UTF), and granting access when the one user passes the Turing test; and
delaying, via the investigator computing device, access for a non-verified request rate, updating the UTF, and updating a table of IP addresses of suspected users when the one user does not pass the Turing test.

17. The method of claim 16, wherein the observer computing device is configured with circuitry to probe local resource usage of one or more associated computing devices and to instruct the firewall node to redirect subsequent requests for cloud services access to the investigator computing device when network link utilization, CPU utilization, or memory allocation usage has been exceeded.

18. The method of claim 16, further comprising:
scheduling jobs received from the firewall computing device or the investigator computing device and automatically scaling incoming requests for access to cloud services when the threshold is exceeded, via a job scheduler node.

19. The method of claim 16, further comprising:
determining whether a concurrent requests per second (CRPS) value has been breached in the requests for access to cloud services by a given IP address.

20. The method of claim 19, further comprising:
dropping the requests for access to cloud services when the CRPS value has been breached and the UTF is below a minimum UTF value for the given IP address.
